(19) United States
(12) Patent Application Publication
(10) Pub. No.: US 2026/0310504 A1
(43) Pub. Date: Oct. 8, 2026

(54) Dynamic Operational Memory Footprint Optimization

(71) Applicant: Cribl, Inc., San Francisco, CA (US)

(72) Inventor: Dmitri Yurievich Khokhlov, Mountain View, CA (US)

(21) Appl. No.: 19/634,540

(22) Filed: Mar. 31, 2026

Related U.S. Application Data
(60) Provisional application No. 63/784,486, filed on Apr. 7, 2025.

(51) Int. Cl. G06F 9/50

(52) U.S. Cl. CPC G06F 9/5016

(57) ABSTRACT

Applications with variable, environment-dependent memory requirements may be unable to effectively optimize their own memory consumption using static thresholds or fixed limits, particularly when the application operates as a low-priority process in a shared computing environment. A dynamic operational memory footprint controller embedded within an application calibrates a floor operational memory footprint by applying controlled paging-out pressure through an operating system memory management API and incrementally adjusting until performance criteria are satisfied. During runtime, the controller collects process-level and system-level activity metrics, normalizes them relative to the calibrated range, and applies a machine learning model to generate candidate adjustments to the operational memory footprint limit of the application. The controller applies adjustments as soft memory pressure through the API, facilitating dynamic memory reduction without hard limits that may cause application instability.

### CROSS REFERENCE TO RELATED APPLICATIONS

This application claims the benefit of U.S. Provisional Patent Application Serial No. 63/784,486, filed Apr. 7, 2025, the entire disclosure of which is incorporated herein by reference.

### FIELD

The present disclosure relates to memory management in a computing system, and more particularly to dynamic operational memory footprint optimization.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a computer system for dynamic operational memory footprint optimization.

FIG. 2 is a block diagram of an example internal configuration of a computing device.

FIG. 3 is a diagram of an example data flow associated with dynamic operational memory footprint optimization.

FIG. 4 is a block diagram of an example dynamic operational memory footprint controller.

FIG. 5 is a flow diagram of an example process associated with dynamic operational memory footprint optimization.

FIG. 6 is a flow diagram of another example process associated with dynamic operational memory footprint optimization.

FIG. 7 is a block diagram of another example dynamic operational memory footprint controller.

FIG. 8 is a flow diagram of another example process associated with dynamic operational memory footprint optimization.

FIG. 9 is a flow diagram illustrating an example of a technique associated with dynamic operational memory footprint optimization.

FIG. 10 is a flow diagram illustrating another example of a technique associated with dynamic operational memory footprint optimization.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, network node, system, computer program product, non-transitory computer-readable medium, computing device, and/or processing system as described or substantially described herein with reference to and as illustrated by the drawings and the specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of signals or data may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

In modern computing environments, applications running on operating systems may encounter challenges related to memory management and resource allocation. These challenges arise from limitations of physical memory resources and the need to efficiently utilize available memory across multiple concurrent processes. Multiple running applications often compete for limited memory resources, leading to potential performance degradation, increased latency, and system instability. The necessity to balance memory usage across various applications and system processes may result in suboptimal memory allocation, excessive paging, and reduced overall system performance. These memory management issues not only diminish the efficiency of individual applications but may also lead to decreased responsiveness and reliability of the entire computing system. These problems may become more apparent when a new application is added to an existing environment and that addition results in an actual or perceived degradation in performance that may be, or appear to be, attributable to the new application. Consequently, adoption and use of the new application, and the resulting services and benefits provided by that application, may be jeopardized. In such situations, it may be beneficial for such a new application to actively minimize its memory footprint, even if performance of that new application is reduced to some extent.

Memory management systems in operating systems are generally designed with static or semi-static allocation strategies, which pose constraints for applications with dynamic memory requirements. In these and other systems, applications may, for example, over-allocate memory to anticipate peak usage or risk performance issues during high-demand periods. Additionally, a lack of real-time adaptation in memory allocation may result in inefficient utilization of available resources, leading to unnecessary paging activity. These challenges may be further amplified in scenarios where multiple memory-intensive applications are running concurrently, with varying and unpredictable memory demands.

Furthermore, the problem may be compounded by the diverse and unpredictable nature of modern software environments. Applications may exhibit widely varying memory usage patterns depending on the specific environment and machine they are installed and executed within, along with their specific tasks, interactions, and data processing requirements. This variability makes it challenging to implement a one-size-fits-all approach to memory management. Additionally, the increasing prevalence of virtualized and containerized environments introduces additional layers of complexity to memory allocation and optimization, as resources must be efficiently shared among multiple isolated instances.

In some cases, an application for collecting and processing observability data (e.g., logs, metrics, application data, etc.) may be installed in a customer environment and share resources with other processes on a computer system. It may be beneficial to minimize memory usage while having limited control over the environment. The application may be a low priority application and should not reduce performance of other processes, even if it delays application actions. Existing techniques tend to include blunt instruments - fixed thresholds, for example. These techniques often do not facilitate effective dynamic adjustment of an operational memory footprint (e.g., a working set size (WSS) or a resident set size (RSS)).

Implementations of this disclosure address problems such as these by providing dynamic operational memory footprint optimization that adapts to the changing memory requirements of an application in real-time. A dynamic operational memory footprint controller monitors application and system-level metrics in real-time, employs machine learning (ML) algorithms to analyze these metrics, and dynamically adjusts the operational memory footprint limit of the application. This approach may facilitate efficient memory utilization while maintaining application performance across diverse computing environments.

A challenge in dynamic memory management is that the viable operating range of a memory of the application footprint is not known a priori and varies across computing environments. Some control-theoretic approaches, such as proportional-integral-derivative (PID) controllers, may be inadequate for this problem because the set point (the target memory allocation) is unknown and the problem is inherently multi-dimensional, involving concurrent consideration of memory usage, paging fault rates, central processing unit utilization, and disk input/output activity. Implementations of this disclosure address this challenge through a calibration procedure in which the controller applies controlled paging-out pressure to the application by setting an initial operational memory footprint limit to a value that induces paging-out, and then incrementally adjusting the limit until the performance of the application metrics satisfy performance criteria. This process discovers a floor operational memory footprint, which is the minimum memory allocation at which the application may operate without unacceptable performance degradation. The floor, together with the initial steady-state footprint, defines the viable memory operating range of the application within the specific environment. This calibrated range then serves as the foundation for subsequent ML-driven adjustments, providing normalization anchors that may facilitate meaningful comparison of metrics across diverse deployment environments.

In contrast to memory management approaches that impose hard memory limits, which may result in application termination or out-of-memory conditions when limits are exceeded, implementations described herein apply dynamic memory pressure through controlled adjustment of the operational memory footprint of the application limit. The operational memory footprint limit, such as a working set size limit, functions as a soft constraint that influences the page replacement behavior of the operating system rather than imposing an absolute cap on memory usage. When the controller reduces the operational memory footprint limit, the operating system is encouraged to swap out less frequently accessed pages, but the application is not prevented from accessing memory beyond the limit if genuinely required. This soft-pressure architecture may facilitate the controller aggressively exploring reduced memory allocations through ML-driven adjustments without risking application instability, because the operating system retains the ability to provide additional memory in response to actual demand.

Some implementations include a dynamic operational memory footprint controller (which may be referred to, interchangeably, as a dynamic working set controller (DWSC)). The dynamic operational memory footprint controller may be embedded within an application or operate as a separate component. The dynamic operational memory footprint controller may be configured to adjust an operational memory footprint limit, which in some implementations may be a WSS limit or an RSS limit. As used herein, the term "operational memory footprint" refers to an amount of physical memory (e.g., random access memory (RAM)) associated with an application at a given time. This may include, but is not limited to, a resident set of the application, which represents the subset of the virtual memory of the application that is currently mapped to physical memory (RAM) for quick access, or a working set of the application, which represents the subset of the virtual memory of the application that is either currently mapped to RAM for quick access or that has been recently swapped out from the RAM. In this context, "recently" may refer to a time period that may be specified by the operating system, the application, or a combination thereof.

In some implementations, the dynamic operational memory footprint controller may include an initialization component, a metrics collection component, an ML component, an adjustment control component, and a feedback component. The initialization component performs initial setup operations, including obtaining an initial operational memory footprint of the application and determining a floor operational memory footprint.

The metrics collection component gathers process activity metrics and system activity metrics. Process activity metrics may include the current operational memory footprint, quantity of hard and soft page faults within a time period, memory usage trends, and CPU utilization metrics associated with the application. System activity metrics may include available memory, paging file usage metrics, overall central processing unit (CPU) utilization, and disk input/output (I/O) metrics related to paging activities. These metrics provide a comprehensive view of the memory of the application usage patterns and the overall system state.

The ML component processes the collected metrics to determine appropriate adjustments to the operational memory footprint limit. In some implementations, this component may utilize a pre-trained regression model or decision tree model to predict optimal adjustments. In some implementations, this component may employ reinforcement learning (RL) techniques, providing a mechanism by which the system can adapt and improve its decision-making process over time based on observed outcomes.

The adjustment control component implements the determined adjustments to the operational memory footprint limit. This may involve invoking an application programming interface (API) provided by the operating system to modify the limit. The term "operational memory footprint limit" may refer to a working set size limit in Windows environments or a resident set size limit in Unix-like systems. The adjustment process may involve gradual changes, such as step-wise increases or decreases, to minimize disruption to the performance of the application.

In some implementations, the controller may employ an RL agent associated with a policy. The agent defines states based on current and subsequent activity metrics, selects actions (adjustments) based on the current state, and updates its policy based on rewards derived from resulting performance metrics. This approach provides a mechanism by which the system can continually refine its adjustment strategies, adapting to changing application behaviors and system conditions over time.

The feedback component monitors the effects of the adjustments and provides data back to the machine learning component. This creates a closed-loop system where the outcomes of previous adjustments inform future decisions, providing a mechanism by which the controller can learn and improve its performance over time. Such a closed-loop system may facilitate effective dynamic adjustment in more environments, including those where communication may not be permitted or possible with external systems for controlling the dynamic adjustment. In some implementations, this may involve determining a performance impact corresponding to each adjustment and updating the parameters of the machine learning model accordingly.

By dynamically managing the operational memory footprint, implementations of this disclosure provide a technical solution that addresses the challenges of efficient memory utilization in modern computing environments and improve the functioning of such computing devices that execute such applications. The system adapts to varying hardware configurations, application complexities, and system loads, offering a more sophisticated and tailored approach to memory management compared to traditional static or semi-static allocation strategies. This technical advancement improves overall system performance, reduces unnecessary paging, and enhances the efficiency of memory usage across diverse computing scenarios.

Unlike some memory management solutions, which primarily control heap memory allocation, implementations described herein may dynamically adjust the entire WSS of an application, providing a more comprehensive approach to memory footprint optimization. Furthermore, traditional approaches operate at a global operating system level or are applied to containers, whereas the dynamic operational memory footprint controller described herein is integrated within the application itself, facilitating application-specific and more nuanced memory management without requiring superuser or root privileges in many cases. This may facilitate memory optimization at the application level without interfering with system-wide resource constraints, thereby improving both application performance and overall system stability. Because the controller operates from within the application process, it may have direct access to application-level metrics (such as internal memory usage trends and task-specific resource consumption) that are not visible to OS-level or container-level memory managers. The application-embedded architecture may facilitate deployment on customer infrastructure without requiring modifications to the host operating system, hypervisor, or container runtime, and without requiring elevated permissions that customer security policies may prohibit. In some implementations, the dynamic operational memory footprint controller may be deployed as a dynamically loadable library (e.g., a dynamic-link library (DLL) on Windows or a shared object (SO) on Unix-like systems), facilitating injection into an application at runtime without recompilation of the application.

While some approaches might impose hard limits that could lead to application crashes under out-of-memory (OOM) conditions, the dynamic operational memory footprint optimization described herein may apply dynamic memory pressure through controlled WSS reduction (e.g., by leveraging the SetProcessWorkingSetSizeEx API) in a manner that encourages the operating system to selectively swap out less frequently accessed data without causing abrupt application termination. Unlike traditional memory management approaches that impose rigid memory constraints, potentially terminating processes when memory limits are exceeded, the dynamic operational memory footprint optimization described herein facilitates soft constraints that may provide a mechanism by which the application can adapt its memory usage dynamically without causing system instability. This approach may facilitate responsive and functional applications, even under varying system load conditions. Moreover, the dynamic operational memory footprint optimization described herein is designed to be broadly applicable and does not directly interact with or depend on specific garbage collection (GC) mechanisms, making it applicable to a wider range of applications and programming paradigms.

Some implementations may include a "simple" approach that applies periodic memory pressure without considering application metrics and a "smart" approach that leverages various system and application metrics, incorporating ML techniques to make informed decisions about dynamic adjustments. The "simple" version may cause the operational memory footprint (e.g., the WSS) to drop to a floor value that may be used as an input feature in an ML model associated with the "smart" approach. The "smart" approach may facilitate fine-grained tuning of memory limits by analyzing real-time system and application metrics, making predictive adjustments based on historical data and reinforcement learning models.

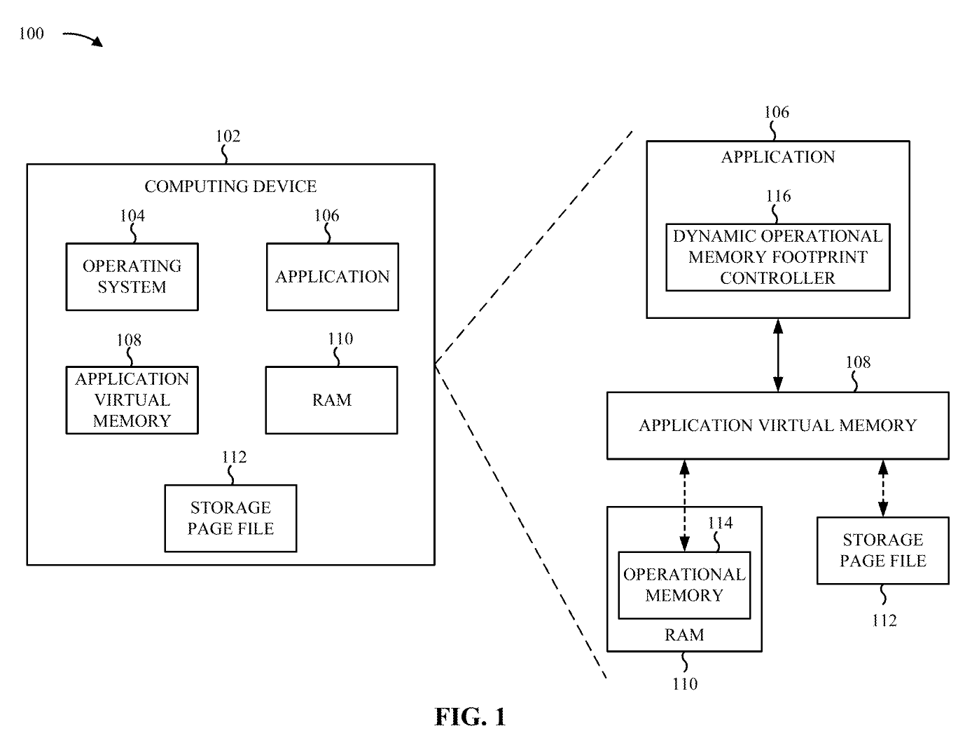

FIG. 1 is a block diagram of an example of a computing system 100 (which may also be referred to as a computer system) for dynamic operational memory footprint optimization. As shown, the computing system 100 includes a computing device 102, an operating system 104, an application 106, application virtual memory 108, RAM 110, and a storage page file 112. The RAM 110 includes operational memory 114. The application 106 includes a dynamic operational memory footprint controller 116, which may be configured to manage an operational memory footprint associated with the operational memory 114 to provide efficient memory management and optimization.

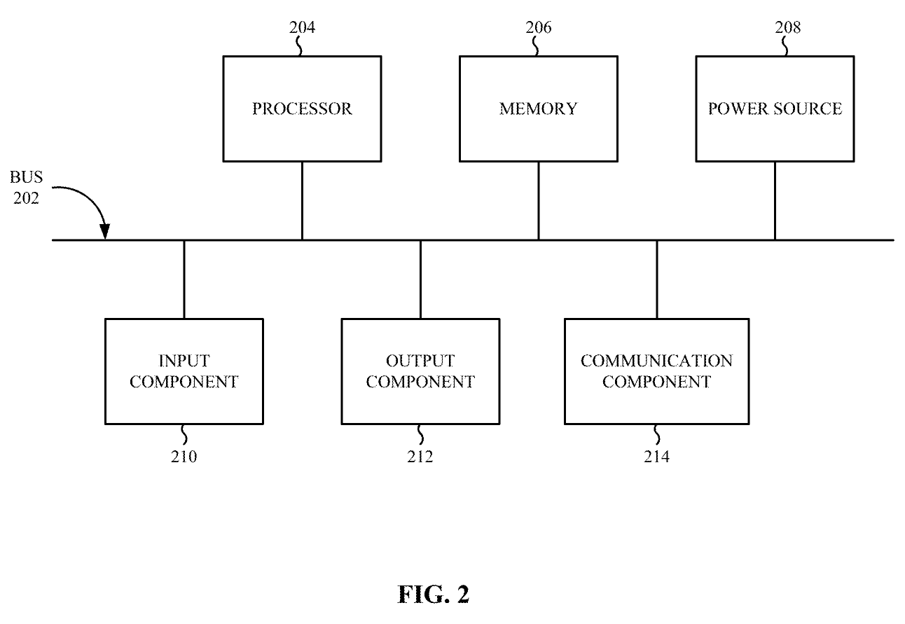

The computing device 102 represents the hardware infrastructure on which the other components of the computing system 100 operate. In some implementations, the computing device 102 may be a personal computer, a server, a mobile device, or any other suitable computing platform capable of executing the operating system 104 and supporting the application 106. In some implementations, the computing device 102 may be, be similar to, include, or be included in the computing device 200 shown in FIG. 2.

The operating system 104 is installed on the computing device 102 and provides a software layer between the hardware components of the computing device 102 and the application 106. In some implementations, the operating system 104 may be configured to manage system resources, including memory allocation and process scheduling. The operating system 104 may implement various memory management techniques, such as virtual memory and paging, to efficiently utilize the available physical memory.

The application 106 runs on top of the operating system 104 and represents a software program designed to perform specific tasks or functions. In some implementations, the application 106 may be a user-facing application, a background service, or a system utility. In some implementations, for example, the application 106 may be an application configured to collect and process observability data. The application 106 interacts with the operating system 104 to request and utilize system resources, including memory.

The application virtual memory 108 is a memory management abstraction provided by the operating system 104 to the application 106. In some implementations, the application virtual memory 108 may present a contiguous address space to the application 106, regardless of the physical memory layout. This abstraction provides a mechanism by which the application 106 can address more memory than what is physically available by utilizing both RAM 110 and the storage page file 112. In some implementations, the application virtual memory 108 may include, or be included in, the operational memory 114. For example, the application virtual memory 108, or a portion thereof, may be mapped to the operational memory 114.

The RAM 110 represents the physical random access memory installed in the computing device 102. In some implementations, the RAM 110 may provide fast, volatile storage for actively used data and instructions. The operating system 104 may manage the allocation and deallocation of RAM 110 among various processes and applications running on the computing device 102.

The storage page file 112 is a designated area on a non-volatile storage device, such as a hard disk or solid-state drive, used by the operating system 104 to extend the available memory beyond the physical RAM 110. In some implementations, the storage page file 112 may store less frequently accessed memory pages, providing a mechanism by which the operating system 104 can free up RAM 110 for more immediate needs. In some implementations, the application virtual memory 108, or a portion thereof, may be mapped to the storage page file 112.

The operational memory 114 represents the subset of the application virtual memory 108 that is actively mapped to RAM 110, facilitating quick access by the application 106. In some implementations, the operational memory 114 may be analogous to the working set of the application 106 in Windows environments or the resident set in Unix-like systems. The size and composition of the operational memory 114 may dynamically change based on the memory of the application usage patterns and system-wide memory pressure.

The dynamic operational memory footprint controller 116 is a component of the computing system 100, designed to optimize the memory of the application usage in real-time. In some implementations, the dynamic operational memory footprint controller 116 may be embedded within the application 106 or operate as a separate component. The dynamic operational memory footprint controller 116 may, for example, interact with the operating system 104 using an API provided by the operating system 104 to control one or more aspects of an operational memory footprint of the application 106. As indicated above, the dynamic operational memory footprint controller 116 may be referred to as a DWSC.

In operation, the dynamic operational memory footprint controller 116 may continually or periodically monitor activity metrics related to the memory of the application usage and overall system performance. The activity metrics may include process activity metrics and system activity metrics. Process activity metrics may include any number of different types of metrics associated with the operations of the application 106 such as, for example, the current operational memory footprint, quantity of hard and soft page faults within a time period, memory usage trends, or CPU utilization metrics associated with the application, among other examples. System activity metrics may include any number of different types of metrics associated with the operations of the operating system 104 such as, for example, available memory, paging file usage metrics, overall CPU utilization, or disk I/O metrics related to paging activities, among other examples.

Based on the collected metrics, the dynamic operational memory footprint controller 116 may employ one or more algorithms, which may include machine learning techniques, to analyze the memory of the application requirements and system conditions. In some implementations, this analysis may result in predictions about future memory needs and potential performance impacts of different memory allocation strategies.

Using the insights gained from its analysis, the dynamic operational memory footprint controller 116 may generate instructions to adjust the operational memory footprint limit of the application 106. These adjustments may involve increasing or decreasing the amount of operational memory 114 allocated to the operational memory 114 of the application, or modifying the threshold at which memory pages are swapped between RAM 110 and the storage page file 112. In some implementations, for example, the dynamic operational memory footprint controller 116 may generate a candidate adjustment to a current operational memory footprint limit of the application. The candidate adjustment may be based on a predicted rate of change of memory usage, a predicted rate of change of paging faults obtained based on current activity metrics, a floor operational memory footprint, or a step size, among other examples.

The dynamic operational memory footprint controller 116 may communicate its adjustment decisions to the operating system 104 through appropriate system calls or APIs. In some implementations, these adjustments may be made gradually and continually, facilitating fine-tuned optimization that responds to changing application demands and system conditions in real-time.

By dynamically managing the operational memory footprint, the computing system 100 may achieve a balance between efficient memory utilization and application performance. This approach may help reduce unnecessary paging activities, minimize memory-related performance bottlenecks, and improve overall system responsiveness.

In some implementations, the dynamic operational memory footprint controller 116 may incorporate feedback mechanisms to evaluate the effectiveness of its adjustments. By monitoring the impact of previous decisions on application performance and system metrics, the dynamic operational memory footprint controller 116 may refine its optimization strategies over time, potentially leveraging machine learning techniques to improve its decision-making capabilities.

The computing system 100, through the integration of the dynamic operational memory footprint controller 116 with the application 106 and operating system 104, provides a solution for memory management challenges in modern computing environments. This configuration facilitates adaptive and intelligent memory optimization, potentially enhancing application performance and system efficiency across a wide range of hardware configurations and usage scenarios.

FIG. 2 shows a block diagram of an example of a computing device 200 capable of performing functions described herein. The computing device 200 may be, be similar to, include, or be included in, an apparatus for performing one or more methods, processes, algorithms, operations, tasks, and/or techniques, as described herein. The computing device 200 may be, be similar to, include, or be included in, a computing device, a laptop, a workstation, a server device, or a personal computer, among other examples. The computing device 200 includes a bus 202 that interconnects various components or units, such as a processor 204, a memory 206, a power source 208, an input component 210, an output component 212, and a communication component 214, among other examples.

The processor 204 may be a central processing unit, such as a microprocessor, and may include single or multiple processors having single or multiple processing cores. The processor 204 may include another type of device, or multiple devices, configured for manipulating or processing information. For example, the processor 204 may include multiple processors interconnected in one or more manners, including hardwired or networked. The operations of the processor 204 may be distributed across multiple devices or units that may be coupled directly or across a local area or other suitable type of network. The processor 204 may include a cache, or cache memory, for local storage of operating data or instructions.

The memory 206 includes one or more memory components, which may each be volatile memory or non-volatile memory. The memory 206 may include non-transitory memory. The volatile memory may be RAM (e.g., a DRAM module, such as DDR SDRAM). The non-volatile memory of the memory 206 may be a disk drive, a solid state drive, flash memory, or phase-change memory. In some implementations, the memory 206 may be distributed across multiple devices. For example, the memory 206 may include network-based memory or memory in multiple clients or servers performing the operations of those multiple devices.

The memory 206 may include data for access by the processor 204. For example, the memory 206 may include executable instructions, application data, or an operating system, among other examples. The executable instructions may include one or more application programs, which may be loaded or copied, in whole or in part, from non-volatile memory to volatile memory to be executed by the processor 204. For example, the executable instructions may include instructions for performing techniques described in this disclosure. In some implementations, the application data may include functional programs, such as a computational programs, analytical programs, database programs, and so on. The operating system may be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 may be an interface to an external power distribution system. In an example, the power source 208 may be a battery, such as where the computing device 200 is a mobile device or is otherwise configured to operate independently of an external power distribution system. In some implementations, the computing device 200 may include or otherwise use multiple power sources. In some such implementations, the power source 208 may be a backup battery.

The input component 210 and/or the output component 212 may include one or more input interfaces and/or output interfaces configured for facilitating communication between the computing device 200 and one or more peripheral devices such as, for example, one or more sensors, detectors, displays, input devices, or other devices configured for facilitating interaction with the computing device 200 or the environment around the computing device 200. An input device may, for example, include a positional input device, such as a mouse, touchpad, touchscreen, or the like; a keyboard; or another suitable human or machine interface device. An output device may, for example, include a display, such as a liquid crystal display, a cathode-ray tube, a light emitting diode display, or other suitable display. In some implementations, the peripherals devices may include a geolocation component, such as a global positioning system (GPS) location unit. In some examples, the peripheral devices may include a temperature sensor for measuring temperatures of components of the computing device 200, such as the processor 204.

The communication component 214 may include an interface for facilitating a connection or link to a network. The communication component 214 may include a wired network interface or a wireless network interface. The computing device 200 may communicate with other devices via the communication component 214 using one or more network protocols, such as using Ethernet, TCP, IP, power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, a cellular communication protocol, another protocol, or a combination thereof. For example, the computing device 200 may communicate with a database server.

The communication component 214 may include a transceiver, which may include a transmitter or a receiver. In some configurations, one or a combination of antenna(s), modem(s), multiple input multiple output (MIMO) detectors, receive processors, transmit processors, and/or the transmit MIMO processors may be included in the transceiver. The transceiver may be under control of or used by one or more processors, and in some aspects in conjunction with processor-readable code stored in the memory, to perform aspects of the methods, processes, techniques, and/or operations described herein.

In the description herein, sentences describing a system, an apparatus, or a device as taking an action (such as performing, determining, initiating, receiving, calculating, deciding, computing, processing, etc.) are to be understood that some appropriate component of the system, apparatus, or device as taking the action. Such components may refer to hardware and/or software configured to take the action.

An apparatus, computing device (e.g., the computing device 200), one or more components of a computing device, or a system, among other examples, described herein may include one or more chips, system-on-chips (SoCs), chipsets, packages, and/or devices that individually or collectively constitute or comprise a processing system. A processing system may include processor (or "processing") circuitry in the form of one or multiple processors, microprocessors, processing units (such as CPUs, graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as "processors" or collectively as "processor" or "processor circuitry"). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory in the form of one or more memory devices, memory blocks, memory elements or other discrete gate or transistor logic or circuitry, each of which may include tangible storage media such as RAM or read-only memory (ROM), or combinations thereof (all of which may be generally referred to herein individually as "memories" or collectively as "memory" or "memory circuitry"). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively "the radio"), multiple RF chains, or multiple transceivers, each of which may in turn be coupled with one or more of multiple antennas. In some implementations, one or more processors of the processing system include or implement one or more of the radios, RF chains or transceivers. The apparatus may include or may be included in a housing that houses components associated with the apparatus including the processing system.

The terms "processor," "processing circuitry," "processing component," "processor component," "controller," or "controller/processor" may refer to one or more controllers and/or one or more processors. For example, reference to "a/the processor," "a/the controller/processor," or the like (in the singular) should be understood to refer to any one or more of the processors described in connection with FIG. 2, such as a single processor or a combination of multiple different processors. Reference to "one or more processors" should be understood to refer to any one or more of the processors described in connection with FIG. 2.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to "one or more memories" should be understood to refer to any one or more memories of a corresponding device, such as the memory described in connection with FIG. 2. For example, operation described as being performed by one or more memories may be performed by the same subset of the one or more memories or different subsets of the one or more memories.

As used herein, the term "component" is intended to be broadly construed as hardware and/or a combination of hardware and software. "Software" shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code--it being understood that software and hardware may be designed to implement the systems and/or methods based, at least in part, on the description herein.

An "engine" refers to a component constructed, programmed, configured, or otherwise adapted to perform a specific function or set of functions. The term engine as used herein means a tangible device, component, or arrangement of components implemented using hardware, such as by an ASIC or FPGA, for example, or as a combination of hardware and software, such as by a processor-based computing platform and a set of program instructions that transform the computing platform into a special-purpose device to implement the particular functionality. An engine may also be implemented as a combination of the two, with certain functions facilitated by hardware alone, and other functions facilitated by a combination of hardware and software.

In an example, the software may reside in executable or non-executable form on a tangible machine-readable storage medium. Software residing in non-executable form may be compiled, interpreted, translated, or otherwise converted to an executable form prior to, or during, runtime. In an example, the software, when executed by the underlying hardware of the engine, causes the hardware to perform the specified operations. Accordingly, an engine is physically constructed, or specifically configured (e.g., hardwired), or temporarily configured (e.g., programmed) to operate in a specified manner or to perform part or all of any operations described herein in connection with that engine.

Considering examples in which engines are temporarily configured, each of the engines may be instantiated at different moments in time. For example, where the engines include a general-purpose hardware processor core configured using software, the general-purpose hardware processor core may be configured as respective different engines at different times. Software may accordingly configure a hardware processor core, for example, to constitute a particular engine at one instance of time and to constitute a different engine at a different instance of time.

In certain implementations, at least a portion, and in some cases, all, of an engine may be executed on the processor(s) of one or more computers that execute an operating system, system programs, and application programs, while also implementing the engine using multitasking, multithreading, distributed (e.g., cluster, peer-peer, cloud, etc.) processing where appropriate, or other such techniques. Accordingly, each engine may be realized in a variety of suitable configurations, and should generally not be limited to any particular implementation exemplified herein, unless such limitations are expressly called out. As used herein, the term "model" encompasses its plain and ordinary meaning. A model may include, among other things, one or more engines which receive an input and compute an output based on the input.

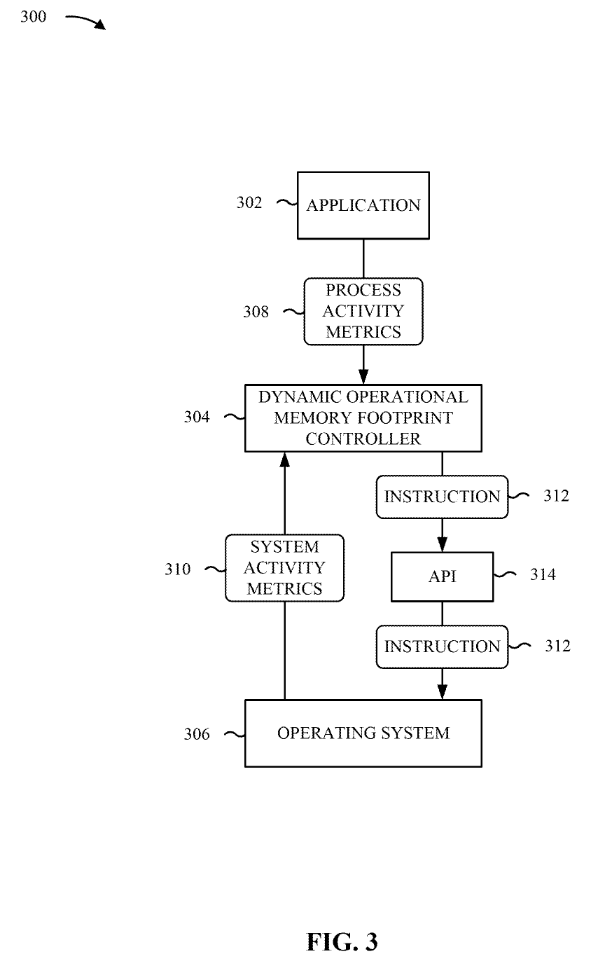

FIG. 3 is a diagram of an example data flow 300 for dynamic operational memory footprint optimization. In some implementations, one or more aspects of the data flow 300 may be performed by the computing system 100 shown in FIG. 1 or the computing device 200 shown in FIG. 2.

The data flow 300 includes an application 302, which represents a software program or process running on an operating system. In some implementations, the application 302 may be similar to or include the application 106 shown in FIG. 1. The application 302 may be configured to perform various tasks or functions, and may require dynamic management of its operational memory footprint to optimize performance and resource utilization.

A dynamic operational memory footprint controller 304 may be communicatively coupled to the application 302 and/or included within the application 302. The dynamic operational memory footprint controller 304 may be a specialized component designed to monitor and adjust the operational memory footprint of the application 302 in real-time. In some implementations, the dynamic operational memory footprint controller 304 may be, be similar to, include, or be included in the dynamic operational memory footprint controller 116 shown in FIG. 1.

The dynamic operational memory footprint controller 304 interfaces with an operating system 306, which manages the overall system resources, including memory allocation. In some implementations, the operating system 306 may be similar to or include the operating system 104 shown in FIG. 1. The operating system 306 provides the underlying platform on which the application 302 runs and interacts with hardware resources.

The dynamic operational memory footprint controller 304 obtains activity metrics, which may be used to facilitate managing the operational memory footprint of the application 302. The activity metrics may include process activity metrics, system activity metrics, or a combination thereof. Process activity metrics 308 represent various data points and measurements related to the performance of the application and resource usage. In some implementations, the process activity metrics 308 may include information such as the current operational memory footprint, the number of page faults occurring within a specific time frame, memory usage trends, or CPU utilization specific to the application 302. Process activity metrics 308 may be obtained, by the dynamic operational memory footprint controller 304, from the application 302, the operating system 306, or a combination thereof.

System activity metrics 310 provide a broader view of the overall system state and resource availability. In some implementations, these metrics may include data on available system memory, paging file usage, overall CPU utilization, or disk I/O activities related to memory management. System activity metrics 310 may be obtained, by the dynamic operational memory footprint controller 304, from the application 302, the operating system 306, or a combination thereof.

The dynamic operational memory footprint controller 304 processes both the process activity metrics 308 and the system activity metrics 310 to make informed decisions about adjusting the operational memory footprint of the application. This processing may involve analyzing trends, predicting future resource needs, or balancing the performance of the application requirements with overall system efficiency, among other examples.

Based on its analysis of the metrics, the dynamic operational memory footprint controller 304 generates an instruction 312. This instruction 312 represents a decision or command to adjust the operational memory footprint of the application 302. In some implementations, the instruction 312 may specify an increase or decrease in a current operational memory footprint limit of the application, or it may indicate that the current limit should be maintained.

The instruction 312 is passed to an API 314, which provides the instruction 312 to the operating system 306. The API 314 serves as an intermediary layer between the dynamic operational memory footprint controller 304 and the operating system 306. The API 314 provides a standardized set of functions and protocols that provide a mechanism by which the dynamic operational memory footprint controller 304 may communicate its decisions to the operating system 306 in a consistent and efficient manner.

In some implementations, the API 314 may translate the instruction 312 or otherwise adapt the instruction 312 to be directly executable by the operating system 306. The operating system 306 implements the requested changes to the operational memory footprint of the application limit based on the instruction 312.

While the API 314 is depicted as being separate from the operating system 306, in many operating systems, the API 314 will be a part of the operating system 306. For example, in some implementations, the API 314 may accept the instruction 312 from a user mode application and the instruction 312 issued by the API 314 may be a privileged system level instruction capable of changing the application's operational memory footprint.

In some implementations, the dynamic operational memory footprint controller 304 may employ machine learning models to enhance its decision-making capabilities. These models could analyze historical patterns in the process activity metrics 308 and system activity metrics 310 to make more accurate predictions about future memory needs and optimize adjustment strategies over time.

The API 314 may support various types of memory management operations. In some implementations, these operations could include adjusting the WSS for Windows-based systems or modifying the RSS for Unix-like systems. The API 314 may also provide functions for querying current memory usage statistics, setting memory usage limits, or requesting specific memory page allocations.

The flow of data and instructions in the data flow 300 creates a feedback loop that facilitates continuous optimization of the operational memory footprint of the application. As the application 302 runs and its resource usage changes, new process activity metrics 308 are generated and fed back into the dynamic operational memory footprint controller 304. Similarly, changes in overall system state result in updated system activity metrics 310. This flow of updated information provides a mechanism by which the dynamic operational memory footprint controller 304 may make real-time adjustments to maintain optimal performance.

The data flow 300 may also incorporate safeguards to prevent overly aggressive memory management that could negatively impact application performance. For instance, the dynamic operational memory footprint controller 304 may be configured with minimum and maximum thresholds for memory allocation, so that the application 302 may have access to a baseline level of resources while reducing the likelihood of excessive memory consumption.

In this configuration, the data flow 300 efficiently manages the operational memory footprint of the application 302, ensuring optimal resource utilization and performance. The integration of real-time metric analysis, dynamic decision-making, and direct communication with the operating system 306 through the API 314 facilitates seamless and continuous memory optimization, thereby enhancing overall system efficiency and application responsiveness.

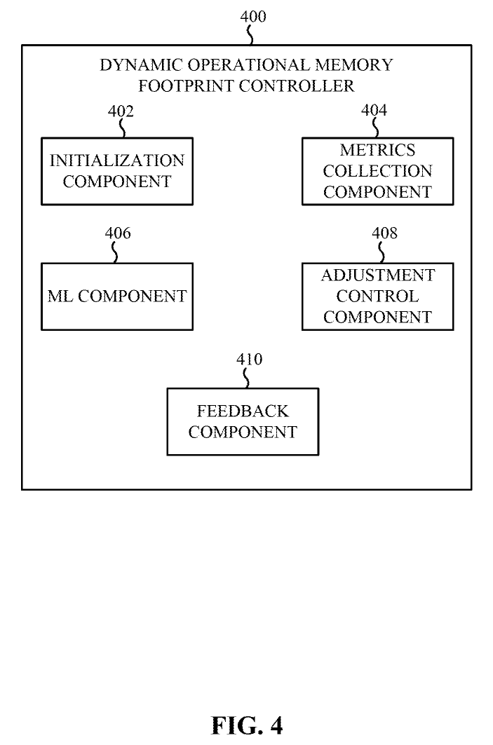

FIG. 4 is a block diagram of an example of a dynamic operational memory footprint controller 400 for optimizing memory usage in a computing system. As shown, the dynamic operational memory footprint controller 400 includes an initialization component 402, a metrics collection component 404, a machine learning component 406, an adjustment control component 408, and a feedback component 410, which are configured to interact with each other to provide dynamic operational memory footprint optimization. The dynamic operational memory footprint controller 400 may be, be similar to, include, or be included in the dynamic operational memory footprint controller 116 shown in FIG. 1 or the dynamic operational memory footprint controller 304 shown in FIG. 3. In some implementations, two or more of the initialization component 402, the metrics collection component 404, the machine learning component 406, the adjustment control component 408, and the feedback component 410 may be integrated. In other implementations, two or more components of the dynamic operational memory footprint controller 400 may be implemented in multiple different components within a system or across multiple systems.

The initialization component 402 may be configured to perform initial setup operations for managing the operational memory footprint. In some implementations, the initialization component 402 may obtain an initial operational memory footprint of an application running on an operating system executing on a computer system. The initialization component 402 may also set an initial operational memory footprint limit associated with the application. In some implementations, the initialization component 402 may determine a floor operational memory footprint of the application by incrementally adjusting an operational memory footprint limit away from the initial operational memory footprint limit in a memory management component of the operating system until a performance metric associated with the application satisfies one or more performance criteria. In some implementations, the initialization component 402 may incrementally adjust the operational memory footprint limit until a resulting rate of paging faults satisfies a paging fault criterion or a paging pressure criterion.

The metrics collection component 404 may be configured to obtain process activity metrics and system activity metrics. In some implementations, the process activity metrics may include the current operational memory footprint, a quantity of hard page faults within a time period, a quantity of soft page faults within the time period, a memory usage trend, or a CPU utilization metric associated with the application. The system activity metrics may include available memory, a paging file usage metric, a CPU utilization metric, or a disk I/O metric associated with paging activities. The metrics collection component 404 may interface with the application and/or the operating system to collect these metrics in real-time.

The machine learning component 406 is configured to process the collected metrics to determine appropriate adjustments to the operational memory footprint limit. In some implementations, the machine learning component 406 may utilize a pre-trained regression model or decision tree model to predict optimal adjustments. The machine learning component 406 may be trained on historical data associated with a plurality of operational memory footprint limit adjustment scenarios. In some implementations, the machine learning component 406 may employ RL techniques, providing a mechanism by which the system may adapt and improve its decision-making process over time based on observed outcomes. In some implementations, the machine learning component 406 may perform an offline learning operation, an online learning operation, and/or an RL learning operation.

In some implementations, the machine learning model may be a gradient-boosted decision tree model, such as an XGBoost model or a LightGBM model. The input feature vector to the model may include normalized values of the current operational memory footprint, the rate of hard page faults, the rate of soft page faults, the memory usage trend (e.g., slope of memory usage over a recent time window), the CPU utilization associated with the application, available system memory, paging file usage, system CPU utilization, and disk I/O metrics associated with paging activities. Each feature may be normalized relative to the initial operational memory footprint and the floor operational memory footprint. Derived features may include fault rates per megabyte of operational memory footprint and ratios of current metric values to their baseline values. The model may be trained on historical data captured from a plurality of operational memory footprint limit adjustment scenarios, which may include data collected from test environments running the application under varying workloads and system configurations. The training data may include tuples of (feature vector, adjustment action, resulting performance outcome), and the model may be trained to minimize a classification loss (e.g., cross-entropy loss) when predicting the adjustment action (step down, keep constant, or step up) or a regression loss (e.g., mean squared error) when predicting the magnitude of adjustment.

The adjustment control component 408 implements the determined adjustments to the operational memory footprint limit. In some implementations, this may involve invoking an API provided by the operating system to modify the limit. The adjustment control component 408 may be configured to generate a candidate adjustment to a current operational memory footprint limit of the application based on a predicted rate of change of memory usage or a predicted rate of change of paging faults obtained based on current activity metrics. The candidate adjustment may be based on the floor operational memory footprint determined by the initialization component 402.

The feedback component 410 monitors the effects of the adjustments and provides data back to the machine learning component 406. In some implementations, the feedback component 410 may determine a performance impact corresponding to adjusting the current operational memory footprint limit based on activity metrics associated with a period of time subsequent to adjusting the current operational memory footprint. This creates a closed-loop system where the outcomes of previous adjustments inform future decisions, providing a mechanism by which the dynamic operational memory footprint controller 400 may learn and improve its performance over time.

To enhance the accuracy of its decisions, the dynamic operational memory footprint controller 400 may employ additional data processing techniques. In some implementations, the machine learning component 406 may determine normalized values of the current activity metrics by normalizing the values relative to the initial operational memory footprint and the floor operational memory footprint. The machine learning component 406 may also determine derived metrics based on these normalized values, which may provide additional context for generating the candidate adjustment. By normalizing metrics relative to the calibrated operating range (defined by the initial operational memory footprint and the floor operational memory footprint), a single machine learning model may produce effective predictions across diverse computing environments with different amounts of physical memory, different application workloads, and different system configurations, because the normalized metrics express resource usage as proportions of the environment-specific operating range rather than as absolute values.

In some implementations, a predicted rate of change of memory usage or a predicted rate of change of paging faults may be determined by computing a derivative or slope of the respective metric over a sliding time window. For example, the system may maintain a buffer of recent metric observations (e.g., the most recent N polling intervals, where each polling interval may be, for example, one second) and compute a linear regression slope or exponential moving average derivative of the memory usage or paging fault rate values within that buffer. The resulting slope or derivative value may represent the predicted rate of change. Alternatively or additionally, the machine learning model may implicitly predict the rate of change by receiving as input features the current metric values along with one or more lagged metric values (e.g., values from one, two, and three polling intervals prior), thereby providing a mechanism by which the model may learn and output predictions that account for the trajectory of the metrics. In some implementations, the derived metrics may include a computed rate of change of the memory usage (e.g., the difference in operational memory footprint between the current polling interval and a prior polling interval, divided by the elapsed time) and a computed rate of change of the paging fault rate (e.g., the difference in cumulative hard page faults between the current polling interval and a prior polling interval, divided by the elapsed time).

The dynamic operational memory footprint controller 400 may also incorporate safeguards to prevent overly aggressive memory management that could negatively impact application performance. For instance, the adjustment control component 408 may be configured with minimum and maximum thresholds for memory allocation, so that the application may have access to a baseline level of resources while reducing the likelihood of excessive memory consumption.

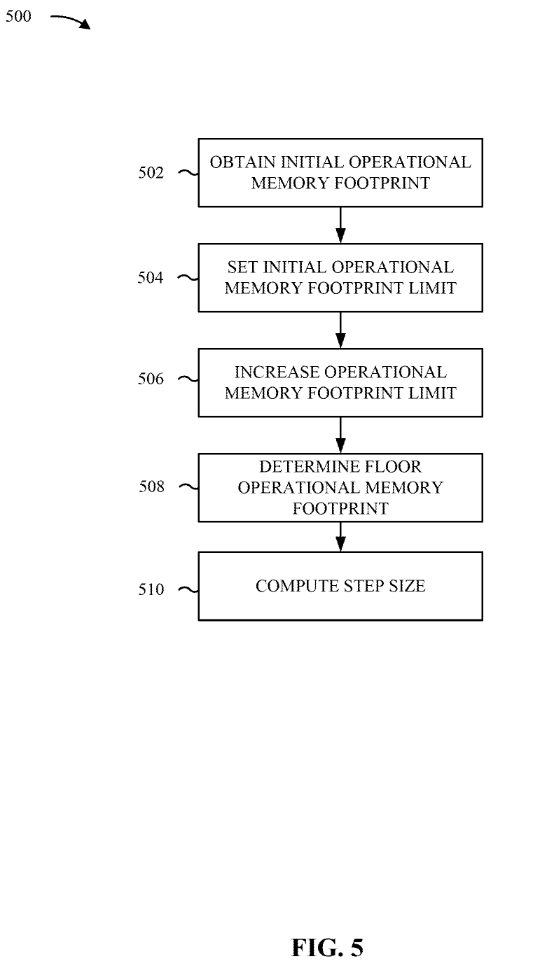

FIG. 5 is a flow diagram of an example process 500 associated with dynamic operational memory footprint optimization. In some implementations, one or more aspects of the process 500 may be performed by the dynamic operational memory footprint controller 400 shown in FIG. 4. The process 500 illustrates a method for initializing and calibrating the operational memory footprint management system, establishing parameters that may be used in subsequent optimization steps.

At step 502, the process 500 includes obtaining an initial operational memory footprint of an application running on an operating system executing on a computer system. In some implementations, this step may be performed by the initialization component 402 shown in FIG. 4. The initial operational memory footprint may represent the steady-state of the application memory usage under normal operating conditions. This value serves as a baseline for subsequent optimization steps and may be used as a reference point for future adjustments.

In some implementations, obtaining the initial operational memory footprint may involve performing an initial calibration operation to determine an estimated normal operational memory footprint range. This calibration process may take into account various factors such as the typical workload of the application, the available system resources, and historical usage patterns. The initial operational memory footprint may then be set based on this estimated normal range, providing a starting point that reflects the expected behavior of the application under typical conditions.

At step 504, the process 500 includes setting an initial operational memory footprint limit associated with the application. In some implementations, this step may be performed by the initialization component 402 shown in FIG. 4. The initial operational memory footprint limit may be set to a value that induces a paging-out pressure that satisfies a pressure criterion. This initial limit serves as a starting point for the calibration process and helps establish the lower bounds of acceptable memory usage for the application.

The process of setting the initial operational memory footprint limit may involve consideration of system resources and application requirements. In some implementations, the initial limit may be set to a relatively low value to encourage efficient memory usage from the outset. The system may employ various strategies to determine an appropriate initial limit, such as analyzing historical data, considering system-wide memory availability, or using predefined heuristics based on the application type.

At step 506, the process 500 includes increasing the operational memory footprint limit. This step may involve incrementally adjusting the operational memory footprint limit away from the initial operational memory footprint limit set in step 504. The adjustment may be made in a memory management component of the operating system. In some implementations, this step may be performed by the initialization component 402 shown in FIG. 4.

The incremental increase in the operational memory footprint limit may be performed in a controlled manner, with each adjustment followed by an evaluation of the performance of the application. The magnitude of each increment may be based on factors such as the initial operational memory footprint, system resources, or predefined step sizes. This gradual approach facilitates a thorough exploration of the memory of the application requirements while minimizing the risk of performance degradation.

At step 508, the process 500 includes determining a floor operational memory footprint of the application. In some implementations, this step may be performed by the initialization component 402 shown in FIG. 4. The floor operational memory footprint represents the lowest operational memory footprint at which the application can operate without performance degradation. This value is determined by continuing the incremental adjustments of step 506 until one or more performance metrics associated with the application satisfy a minimum performance criterion.

The determination of the floor operational memory footprint may involve evaluating multiple performance criteria. These criteria may include various thresholds, ranges, or positive rewards associated with different aspects of application and system performance. For example, a threshold may be set for the maximum acceptable rate of page faults, a range may be defined for acceptable application response times, or a positive reward may be associated with maintaining a certain level of CPU utilization efficiency. In some implementations, the system may consider a combination of criteria, potentially assigning different weights to each based on their relative importance. The specific criteria used may vary depending on the nature of the application, system resources, and overall performance goals.

The determination of the floor operational memory footprint may involve monitoring various performance metrics as the operational memory footprint limit is adjusted. These metrics may include factors such as the rate of page faults, application response time, or other indicators of system performance. The process may continue until a balance is found between minimizing memory usage and maintaining acceptable application performance.

In some implementations, the floor operational memory footprint may be determined by incrementally increasing the operational memory footprint limit until a resulting rate of paging faults is reduced by an amount that satisfies a criterion. This approach recognizes that excessive paging activity may impact application performance and aims to find the minimum memory allocation that keeps paging activity within acceptable limits.

In some implementations, determining the floor operational memory footprint may include setting the initial operational memory footprint limit to a value substantially below the initial operational memory footprint (e.g., 10-20 % of the initial operational memory footprint) to induce paging-out pressure that satisfies a pressure criterion. The system may then incrementally increase the operational memory footprint limit by a predetermined increment (e.g., 1-5 % of the initial operational memory footprint per increment) while monitoring the rate of hard page faults. After each increment, the system may wait for a stabilization period (e.g., one to five polling intervals) to provide a mechanism by which the memory manager of the operating system may respond to the new limit. The floor operational memory footprint may be identified as the operational memory footprint limit at which the rate of hard page faults drops below a threshold (e.g., fewer than 10 hard page faults per second) or drops by a predetermined percentage (e.g., 50 % or more) relative to the rate observed at the initial low limit. In some implementations, the floor operational memory footprint may alternatively be determined as the limit at which application response latency returns to within a predetermined factor (e.g., 2x) of the baseline response latency observed at the initial operational memory footprint.

While the floor operational memory footprint may serve as a useful reference for normalization, calibration, and feature generation, it may not be a required component of the disclosed subject matter. In some implementations, the determination of the floor operational memory footprint may be omitted entirely. Such implementations may operate effectively without explicitly identifying a floor operational memory footprint value, instead relying on real-time system and application metrics for operational memory footprint optimization.

At step 510, the process 500 includes computing a step size. In some implementations, this step may be performed by the initialization component 402 shown in FIG. 4. The step size (which may also be referred to as an adjustment step size) represents the magnitude of adjustments that will be made to the operational memory footprint limit during subsequent optimization processes. Computing the step size may involve considering the difference between the initial operational memory footprint obtained in step 502 and the floor operational memory footprint determined in step 508.

In some implementations, determining the step size may include computing the difference between the initial operational memory footprint and the floor operational memory footprint, and then dividing this difference into a set of steps. The quantity of steps in the set may be specified based on various factors, such as the desired granularity of control or the expected variability in the memory of the application requirements.

The computed step size may facilitate fine-grained control over subsequent adjustments to the operational memory footprint limit. By using a step size derived from the observed memory usage of the application range, the system may make more informed and contextually appropriate adjustments, potentially improving the efficiency and effectiveness of the optimization process.

In some implementations, the process 500 may incorporate additional steps or variations to enhance its effectiveness or adaptability. For example, the process may include a step for validating the determined floor operational memory footprint by running the application under various load conditions and verifying that performance remains acceptable. This validation step may help improve the robustness of the optimization process across different usage scenarios.

The process 500 may also include steps for handling edge cases or exceptional conditions. For instance, if the memory of the application usage patterns are highly variable or unpredictable, the process may incorporate adaptive techniques for dynamically adjusting the floor operational memory footprint or step size based on ongoing observations of the behavior of the application.

In some implementations, the process 500 may include steps for integrating with other components of the dynamic operational memory footprint controller. For example, the computed step size and floor operational memory footprint may be passed to a machine learning component, such as the machine learning component 406 shown in FIG. 4, to be used as input features or reference points in subsequent optimization decisions.

The process 500 may also include steps for storing and managing the determined parameters. This may involve persisting the initial operational memory footprint, floor operational memory footprint, and computed step size in a data store for use in future optimization cycles or for analysis and reporting purposes. In some implementations, these stored parameters may be periodically updated or recalibrated to account for changes in the behavior of the application or system conditions over time.

By establishing these parameters through a systematic process, the dynamic operational memory footprint optimization system may be well-positioned to make informed and effective adjustments to the memory of the application usage. The process 500 provides a foundation for subsequent optimization steps, providing a mechanism by which the system may balance efficient memory utilization with maintaining application performance across diverse computing scenarios.

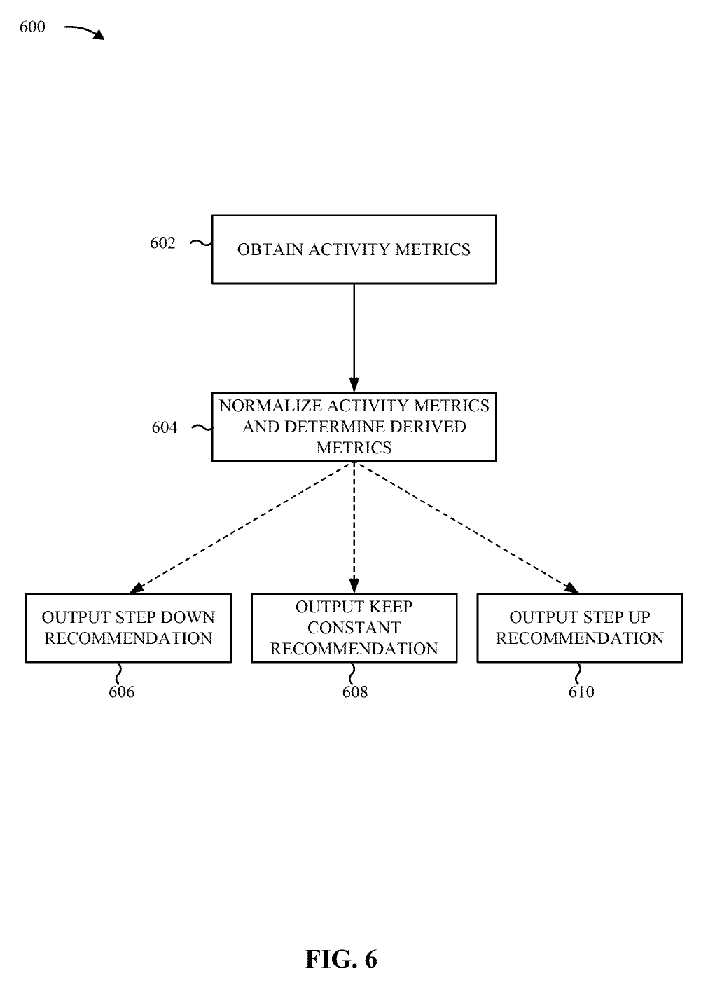

FIG. 6 is a flow diagram of an example process 600 associated with dynamic operational memory footprint optimization. In some implementations, one or more aspects of the process 600 may be performed by the dynamic operational memory footprint controller 400 shown in FIG. 4. The process 600 illustrates a method for generating operational memory footprint limit adjustments based on current activity metrics.

At step 602, the process 600 includes obtaining activity metrics. In some implementations, this step may be performed by the metrics collection component 404 shown in FIG. 4. The activity metrics may include process activity metrics corresponding to an application and system activity metrics corresponding to an operating system. In some implementations, the process activity metrics may include the current operational memory footprint, a quantity of hard page faults within a time period, a quantity of soft page faults within the time period, a memory usage trend, or a central processing unit utilization metric associated with the application. The system activity metrics may include available memory, a paging file usage metric, a central processing unit utilization metric, or a disk input/output metric associated with paging activities.

The metrics collection component may be configured to gather these metrics from various sources within the computing system, providing a comprehensive view of both application-specific and system-wide resource utilization. In some implementations, obtaining the activity metrics may involve interfacing with both the application and the operating system to collect these metrics in real-time. This continuous or periodic collection of metrics may facilitate the dynamic nature of the operational memory footprint optimization process.

Following step 602, the process 600 proceeds to step 604, which involves normalizing the activity metrics and determining derived metrics. In some implementations, this step may be performed by the machine learning component 406 shown in FIG. 4. Normalizing the activity metrics may involve scaling the metrics relative to an initial operational memory footprint and a floor operational memory footprint. These reference points may have been determined during an initialization process, such as the process 500 shown in FIG. 5.

The normalization process may facilitate ensuring that different metrics are comparable and may be processed effectively by the machine learning model. In some implementations, determining normalized values of the current activity metrics may involve normalizing the values relative to the initial operational memory footprint and the floor operational memory footprint. This normalization may provide a consistent scale for various metrics, facilitating more accurate comparisons and analysis.

In addition to normalization, step 604 may include determining derived metrics based on the normalized values. These derived metrics may provide additional context and insights for the adjustment decision-making process. For example, derived metrics may include fault rates per megabyte of operational memory footprint or memory usage trends over time. The combination of normalized metrics and derived metrics may provide a set of features for the machine learning model to analyze.

From step 604, the process 600 may proceed to analyze the normalized and derived metrics using a machine learning model. This model may be implemented as a neural network, decision tree, or other suitable algorithm trained on historical data of memory usage patterns and their corresponding performance outcomes. The machine learning component may process the input features, which include the normalized activity metrics and derived metrics, to predict the most appropriate adjustment to the operational memory footprint limit.

In some implementations, the machine learning model may output one of three possible recommendations: step down 606, keep constant 608, or step up 610. The step down recommendation may be generated based on current activity metrics indicating (1) that a paging activity metric satisfies a paging criterion and (2) a stable or decreasing memory usage. The keep constant recommendation may be produced when the current memory allocation appears to be well-balanced, with no inferred benefit to either increasing or decreasing the footprint. The step up recommendation may be generated when the model predicts that additional memory allocation could lead to improved application performance or reduced system stress.

The machine learning component may employ various techniques to improve the accuracy and reliability of its predictions. For example, it may utilize ensemble methods, combining predictions from multiple models to arrive at a final recommendation. In some implementations, the component may incorporate confidence scores with each prediction, providing a mechanism by which the system may make more informed decisions about when to act on the recommendations of the model. In some cases, the machine learning component may also adapt its predictions based on feedback from previous adjustment outcomes, continually refining its decision-making process over time.

In some implementations, the machine learning component may employ a machine learning model to generate these recommendations. The machine learning model may be configured to output a step down prediction, a keep constant prediction, or a step up prediction associated with the current operational memory footprint limit. In some implementations, the model may be configured to output a specific magnitude of operational memory footprint limit adjustment.

In some implementations, this model may be trained on historical data associated with a plurality of operational memory footprint limit adjustment scenarios. The training process may involve offline training operations, online learning operations, or reinforcement learning operations, providing a mechanism by which the model may continually refine its decision-making capabilities based on observed outcomes.

The process 600 may incorporate safeguards to prevent overly aggressive memory management that could negatively impact application performance. For instance, the system may be configured with minimum and maximum thresholds for memory allocation, so that the application may have access to a baseline level of resources while reducing the likelihood of excessive memory consumption.

After a recommendation is generated, the process 600 may involve implementing the recommended adjustment. This may include outputting an instruction to cause a memory management component to adjust the current operational memory footprint limit based on the candidate adjustment. In some implementations, this may involve invoking an application programming interface (API) provided by the operating system to modify the limit.

The adjustment process may involve gradual changes to minimize disruption to the performance of the application. The magnitude of these adjustments may be based on the step size computed during the initialization process, facilitating fine-tuned control over the operational memory footprint.

In some implementations, the adjustment magnitudes may be asymmetric between step down and step up actions. A step down adjustment may decrease the current operational memory footprint limit by a fraction of the step size (e.g., one-half of the step size), while a step up adjustment may increase the current operational memory footprint limit by a multiple of the step size (e.g., two times the step size). This asymmetry reflects the different risk profiles of the two adjustment directions: reducing the operational memory footprint below what the application requires may trigger cascading page faults that degrade performance of both the application and other processes sharing the computing system, whereas over-allocating memory is recoverable because the operating system may reclaim excess memory through normal page replacement. The cautious step-down and aggressive step-up approach may facilitate maintaining a low memory footprint during stable operation while rapidly recovering when the memory of the application demands increase.

Following the adjustment, the process 600 may include a feedback mechanism to evaluate the effectiveness of the adjustment. This may involve determining a performance impact corresponding to the adjustment based on activity metrics associated with a period of time subsequent to adjusting the current operational memory footprint. The results of this evaluation may be used to update parameters of the machine learning model, creating a closed-loop system where the outcomes of previous adjustments inform future decisions.

In some implementations, the process 600 may be part of a larger reinforcement learning process. This may involve initializing a reinforcement learning agent associated with a policy, defining states based on activity metrics, selecting actions (adjustments) based on the current state, and updating the policy based on rewards derived from resulting performance metrics. This approach may facilitate the system to continually refine its adjustment strategies, adapting to changing application behaviors and system conditions over time.

The process 600 provides a comprehensive approach to dynamic operational memory footprint optimization, balancing efficient memory utilization with maintaining application performance. By incorporating machine learning and adaptive strategies, the process may facilitate enhancing overall system performance, reducing unnecessary paging, and improving the efficiency of memory usage across diverse computing scenarios.

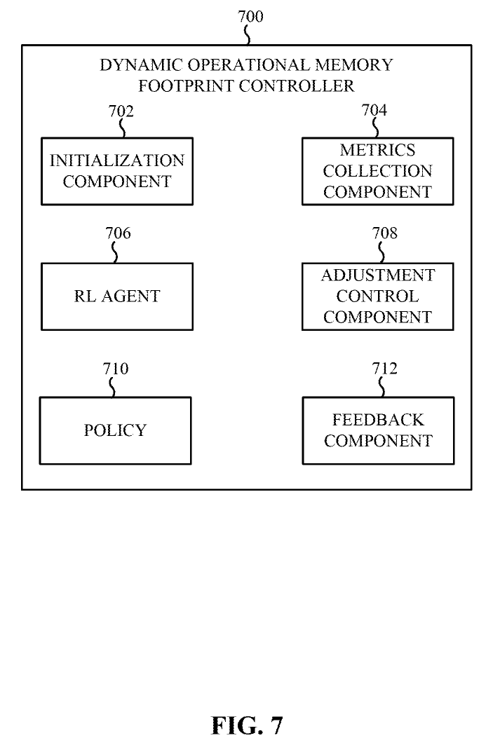

FIG. 7 is a block diagram of an example of a dynamic operational memory footprint controller 700 for optimizing memory usage in a computing system. The dynamic operational memory footprint controller 700 may be, be similar to, include, or be included in the dynamic operational memory footprint controller 116 shown in FIG. 1 or the dynamic operational memory footprint controller 304 shown in FIG. 3.

As shown, the dynamic operational memory footprint controller 700 includes an initialization component 702, a metrics collection component 704, an RL agent 706, an adjustment control component 708, a policy 710, and a feedback component 712, which are configured to interact with each other to provide dynamic operational memory footprint optimization. In some implementations, two or more of the initialization component 702, the metrics collection component 704, the RL agent 706, the adjustment control component 708, the policy 710, and the feedback component 712 may be integrated. In other implementations, two or more components of the dynamic operational memory footprint controller 700 may be implemented in multiple different components within a system or across multiple systems.

The initialization component 702 may be configured to perform initial setup operations for managing the operational memory footprint. In some implementations, the initialization component 702 may obtain an initial operational memory footprint of an application running on an operating system executing on a computer system. The initialization component 702 may also set an initial operational memory footprint limit associated with the application. In some implementations, the initialization component 702 may determine a floor operational memory footprint of the application by incrementally adjusting an operational memory footprint limit away from the initial operational memory footprint limit in a memory management component of the operating system until a performance metric associated with the application satisfies one or more performance criteria. Performance criteria may be measured as thresholds, differences, ranges, values, or sets, among other examples.

The metrics collection component 704 may be configured to obtain process activity metrics and system activity metrics. In some implementations, the process activity metrics may include the current operational memory footprint, a quantity of hard page faults within a time period, a quantity of soft page faults within the time period, a memory usage trend, or a CPU utilization metric associated with the application. The system activity metrics may include available memory, a paging file usage metric, a CPU utilization metric, or a disk I/O metric associated with paging activities. The metrics collection component 704 may interface with both the application and the operating system to collect these metrics in real-time.

The RL agent 706 is a component of the dynamic operational memory footprint controller 700, designed to process the collected metrics and determine appropriate adjustments to the operational memory footprint limit. In some implementations, the RL agent 706 may employ advanced machine learning techniques to analyze complex patterns in the collected metrics and make informed decisions about memory allocation. The RL agent 706 may be configured to learn from its past decisions and their outcomes, continually improving its decision-making capabilities over time via an RL process.

Similar to human learning, RL trains neural networks through trial and error. Specifically, the neural network produces an output, receives feedback regarding this output, and then learns from the feedback.

The RL agent 706 may be initiated with the policy 710. Problems addressed via RL are typically structured in a consistent format. Specifically, an agent interacts with an environment, maintaining a state within this environment and producing actions that can alter the current state. As the agent interacts with the environment, it may receive both positive and negative rewards for its actions. Positive rewards may be associated with operational memory footprint limits that result in performance metrics satisfying one or more corresponding performance criteria. Negative rewards may be associated with operational memory footprint limits that result in performance metrics failing to satisfy one or more corresponding minimum performance criteria. For example, negative rewards may be associated with memory usage that fails to satisfy a memory usage criterion and/or paging fault rates that fail to satisfy a paging fault criterion. The objective of the agent is to maximize the positive rewards received, although not every action is associated with a reward. Rewards may have a long horizon, necessitating several correct, consecutive actions to generate any positive reward. In mathematical terms, RL may be described as a Markov decision process (MDP). An MDP includes states, actions, rewards, transitions, and a policy. States and actions have discrete values, while rewards are real numbers. In an MDP, a policy (referred to herein, interchangeably as a "policy model") takes a state as input and outputs a probability distribution over possible actions. Given this output, a decision may be made for the action to be taken from a current state, and the transition is then a function that outputs the next state based upon the prior state and chosen action. Using these components, the agent may interact with the environment in an iterative fashion to generate a trained policy.

In some implementations, the reward function may be defined as a weighted combination of a memory efficiency term and a performance penalty term. For example, the reward at a given time step may be computed as: reward = w1 * memory_savings_ratio - w2 * paging_penalty - w3 * latency_penalty, where memory_savings_ratio represents the fraction of memory saved relative to the initial operational memory footprint (e.g., (initial_footprint - current_limit) / initial_footprint), paging_penalty is a term that increases with the rate of hard page faults (e.g., hard_faults_per_second / threshold_faults_per_second, clamped to a maximum value), and latency_penalty is a term that increases when application response latency exceeds a baseline (e.g., max(0, current_latency - baseline_latency) / baseline_latency). The weights w1, w2, and w3 may be tunable hyperparameters that control the trade-off between memory savings and performance preservation. In some implementations, a negative reward may be assigned when the rate of hard page faults exceeds a predetermined threshold (e.g., 50 hard page faults per second) or when the operational memory footprint exceeds a predetermined fraction (e.g., 90 %) of the initial operational memory footprint. A positive reward may be assigned when the operational memory footprint limit is reduced below a target level (e.g., below 60 % of the initial operational memory footprint) while the rate of hard page faults remains below the predetermined threshold. In some implementations, the RL agent may be implemented as a Deep Q-Network (DQN), in which a neural network approximates the Q-value function mapping state-action pairs to expected cumulative rewards.

The policy 710 serves as a guide for the decision-making of the agent process. In some implementations, the policy 710 may define a set of rules or strategies that the RL agent 706 uses to map observed states (based on collected metrics) to actions (adjustments to the operational memory footprint limit). The policy 710 may be updated and refined over time as the RL agent 706 gains more experience and learns from the outcomes of its decisions. In some implementations, the policy 710 may be a machine learning model.

The adjustment control component 708 implements the adjustments determined by the RL agent 706. In some implementations, this may involve invoking an API provided by the operating system to modify the operational memory footprint limit. The adjustment control component 708 may be configured to generate a candidate adjustment to a current operational memory footprint limit of the application based on the output of the RL agent 706. In some implementations, the candidate adjustment may be based on a predicted rate of change of memory usage or a predicted rate of change of paging faults obtained from the current activity metrics.

The feedback component 712 may facilitate the learning process of the RL agent 706. In some implementations, the feedback component 712 may monitor the effects of the adjustments made by the adjustment control component 708 and provide data back to the RL agent 706. This feedback may include information about the performance impact of the adjustments, such as changes in application responsiveness, paging activity, or overall system performance. The feedback component 712 helps create a closed-loop system where the outcomes of previous adjustments inform future decisions, providing a mechanism by which the dynamic operational memory footprint controller 700 may learn and improve its performance over time.

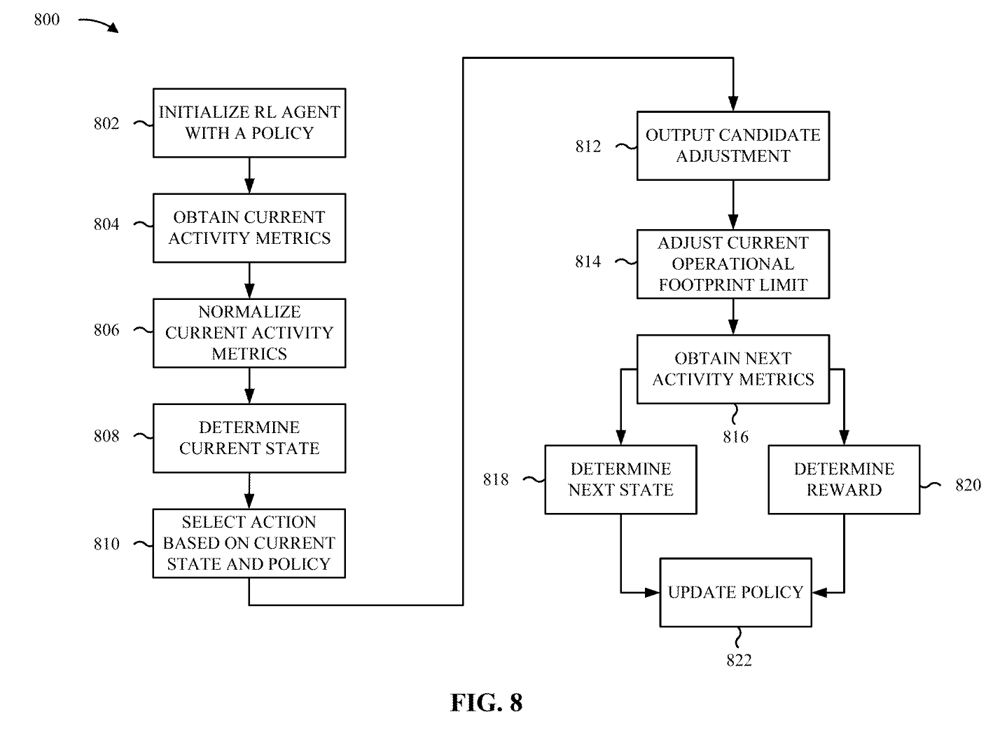

FIG. 8 is a diagram of an example of a process 800 for RL-based operational footprint optimization. In some implementations, one or more aspects of the process 800 may be performed by the dynamic operational memory footprint controller 700 shown in FIG. 7. The process 800 illustrates a method for utilizing RL techniques to dynamically adjust the operational memory footprint of an application, balancing efficient memory utilization with maintaining application performance.

At 802, the process 800 includes initializing an RL agent with a policy. In some implementations, the RL agent may be similar to or include the RL agent 706 shown in FIG. 7. The policy may be a set of rules or strategies that guide the decision-making of the agent process. In some implementations, the policy may be implemented as a machine learning model, such as a neural network, that maps observed states to actions. The initialization process may involve setting up the initial knowledge base of the agent and defining the state space, action space, and reward function that will be used in the RL process.

At 804, the process 800 includes obtaining current activity metrics. In some implementations, these metrics may be collected by a metrics collection component similar to or including the metrics collection component 704 shown in FIG. 7. The current activity metrics may include both process activity metrics corresponding to the application and system activity metrics corresponding to the operating system. Process activity metrics may include the current operational memory footprint, quantity of hard and soft page faults within a time period, memory usage trends, or CPU utilization metrics associated with the application. System activity metrics may include available memory, paging file usage metrics, overall CPU utilization, or disk I/O metrics related to paging activities.

At 806, the process 800 includes normalizing the current activity metrics. This step may involve scaling the metrics relative to the initial operational memory footprint and the floor operational memory footprint determined during an initialization process. Normalization helps to verify that different metrics are comparable and may be processed effectively by the RL agent. In some implementations, this step may also involve calculating derived metrics, such as fault rates per megabyte (MB) of operational memory footprint or memory usage trends over time.

At 808, the process 800 includes determining a current state based on the normalized metrics. The state representation encapsulates the current condition of the system and application, providing the RL agent with the information needed to make decisions. In some implementations, the state may be represented as a vector of normalized metric values, potentially including both raw metrics and derived metrics. The state representation may facilitate the ability of the agent to learn and make informed decisions about memory footprint adjustments.

At 810, the process 800 includes selecting an action based on the current state and policy. The action in this context represents a candidate adjustment to the current operational memory footprint limit. In some implementations, the action space may include discrete options such as "increase limit," "decrease limit," or "maintain current limit," along with associated magnitudes of adjustment. The RL agent uses its current policy to map the observed state to an action, potentially employing techniques such as exploration to balance exploitation of known good actions with exploration of new strategies.

Following the action selection, at 812, the process 800 includes outputting a candidate adjustment. This step involves translating the selected action into a specific adjustment to the operational memory footprint limit. In some implementations, this may involve determining the exact magnitude of the adjustment based on factors such as the current state, the selected action, and predefined step sizes or adjustment ranges.

At 814, the process 800 includes adjusting the current operational memory footprint limit based on the candidate adjustment. In some implementations, this step may involve invoking an API provided by the operating system to modify the limit. The adjustment may be implemented gradually to minimize potential disruptions to the performance of the application. In some implementations, safeguards may be in place to prevent adjustments that could severely impact system stability or application functionality.

At 816, the process 800 includes obtaining next activity metrics. This step is similar to step 804 but occurs after the adjustment has been made. The next activity metrics provide information about the system and application state following the implemented adjustment, providing a mechanism by which the RL agent may assess the impact of its action.

At step 818, the process 800 includes determining a next state based on the next activity metrics. This step is analogous to step 808 but uses the newly obtained metrics to define the state following the adjustment. The next state representation facilitates the RL agent to observe the consequences of its action and learn from the experience.

At 820, the process 800 includes determining a reward based on the next activity metrics. The reward function provides feedback on the quality of the decisions of the agent. In some implementations, the reward may be based on a combination of factors such as changes in application responsiveness, reductions in paging activity, improvements in overall system performance, or the efficiency of memory utilization. The reward function may be designed to encourage actions that balance memory efficiency with maintaining acceptable application performance. The reward may be a positive reward or a negative reward.

At 822, the policy is updated based on the next state and the determined reward. For example, updating the policy may include applying an RL learning algorithm to the policy. The RL algorithm may be configured to map states to candidate adjustments to maximize cumulative rewards (e.g., positive rewards). This step facilitates the learning process of the RL agent. In some implementations, this may involve techniques such as Q-learning or policy gradient methods to adjust the parameters of the policy model based on the observed outcomes of actions. The policy update provides a mechanism by which the agent may refine its decision-making strategy over time, potentially improving its ability to make effective operational memory footprint adjustments.

The process 800 may include mechanisms for handling different operational scenarios. For instance, in some implementations, the RL agent may employ different policies or adjust its learning rate based on detected changes in the behavior of the application or system conditions. This adaptability facilitates the agent to maintain effective performance across varying usage patterns and system loads. In some implementations, the RL agent may perform any number of different types of RL such as, for example, direct policy optimization (DPO) or proximal policy optimization (PPO), among other examples. In some implementations, the RL agent may apply an exploration balancing mechanism configured to cause the agent to explore new adjustment strategies while leveraging actions associated with positive rewards.

In some implementations, the process 800 may integrate with other components of the dynamic operational memory footprint controller. For example, the initialization component may provide initial calibration data to inform the starting policy of the RL agent. The feedback component may supply additional context or performance metrics to enhance the reward calculation process.

By employing RL techniques, the process 800 provides a sophisticated approach to operational memory footprint optimization. The continuous learning and adaptation capabilities of the RL agent facilitate nuanced decision-making that can potentially outperform static or rule-based approaches, especially in complex and dynamic computing environments.

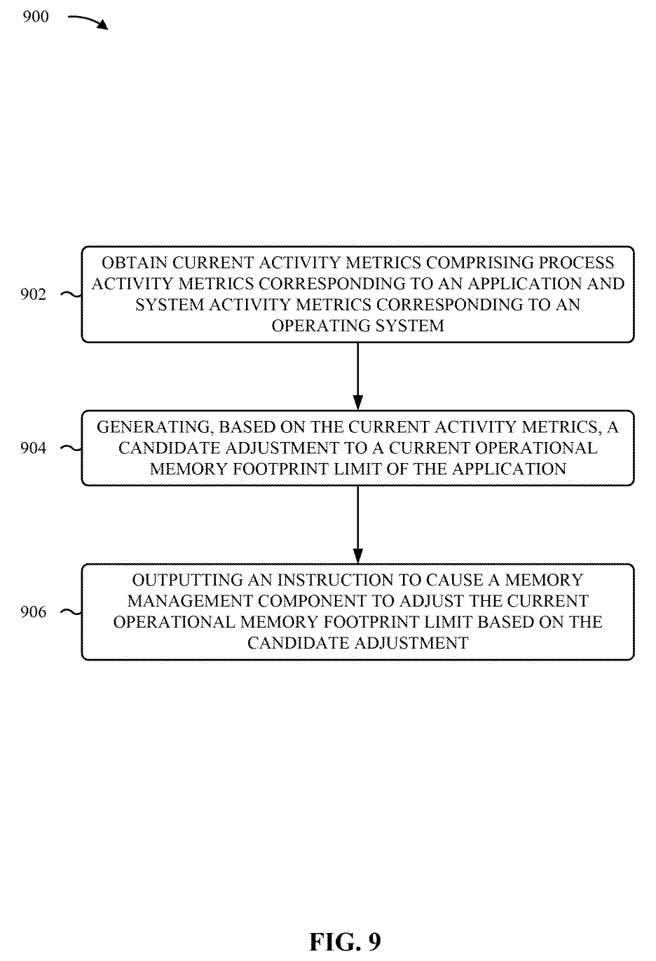

To further describe some implementations in greater detail, reference is next made to examples of techniques which may be performed by or using the dynamic operational memory footprint optimization systems described herein. FIG. 9 is a flowchart of an example of a technique associated with dynamic operational memory footprint optimization. The technique 900 may be executed using computing devices, such as the systems, hardware, and software described with respect to FIGS. 1 - 8. The technique 900 may be performed, for example, by executing a machine-readable program or other computer-executable instructions, such as routines, instructions, programs, or other code. The steps, or operations, of the technique 900, or another technique, method, process, or algorithm described in connection with the implementations disclosed herein may be implemented directly in hardware, firmware, software executed by hardware, circuitry, or a combination thereof.

For simplicity of explanation, the technique 900 is depicted and described herein as a series of steps or operations. However, the steps or operations of the technique 900 can occur in various orders and/or concurrently. Additionally, other steps or operations not presented and described herein may be used. Furthermore, not all illustrated steps or operations may be required to implement a technique in accordance with the disclosed subject matter.

At 902, the technique 900 includes obtaining current activity metrics. For example, a dynamic operational memory footprint controller (such as the dynamic operational memory footprint controller 400 shown in FIG. 4) may obtain current activity metrics comprising process activity metrics corresponding to an application and system activity metrics corresponding to an operating system. In some implementations, the process activity metrics may include the current operational memory footprint, a quantity of hard page faults within a time period, a quantity of soft page faults within the time period, a memory usage trend, or a central processing unit utilization metric associated with the application. The system activity metrics may include available memory, a paging file usage metric, a central processing unit utilization metric, or a disk input/output metric associated with paging activities.

In some implementations, obtaining the current activity metrics may involve interfacing with both the application and the operating system to collect these metrics in real-time. This may be performed by a metrics collection component, such as the metrics collection component 404 shown in FIG. 4. The metrics collection component may be configured to gather data from various sources within the computing system, providing a comprehensive view of both application-specific and system-wide resource utilization.

At 904, the technique 900 includes generating a candidate adjustment to a current operational memory footprint limit of the application based on the current activity metrics. For example, a machine learning component (such as the machine learning component 406 shown in FIG. 4) may process the collected metrics to determine appropriate adjustments to the operational memory footprint limit. In some implementations, this may involve using a pre-trained regression model or decision tree model to predict optimal adjustments.

The candidate adjustment may be based on a predicted rate of change of memory usage or a predicted rate of change of paging faults obtained from the current activity metrics. In some implementations, the candidate adjustment may also be based on a floor operational memory footprint, which may have been determined during an initialization process. This floor operational memory footprint may represent the lowest operational memory footprint at which the application can operate without substantial performance degradation.

In some implementations, generating the candidate adjustment may involve normalizing the current activity metrics relative to an initial operational memory footprint and the floor operational memory footprint. This normalization process may help verify that different metrics are comparable and may be processed effectively by the machine learning model. Additionally, derived metrics may be calculated based on these normalized values, providing further context for the adjustment decision.

The machine learning model used for generating the candidate adjustment may be configured to output various types of predictions. In some implementations, it may output a step down prediction, a keep constant prediction, or a step up prediction associated with the current operational memory footprint limit. Alternatively, it may be configured to output a specific magnitude of operational memory footprint limit adjustment.

At 906, the technique 900 includes outputting an instruction to cause a memory management component to adjust the current operational memory footprint limit based on the candidate adjustment. For example, an adjustment control component (such as the adjustment control component 408 shown in FIG. 4) may implement the determined adjustments to the operational memory footprint limit. This may involve invoking an API provided by the operating system to modify the limit.

In some implementations, the instruction may be output to an API configured to facilitate adjustments to the current operational memory footprint limit. The API may serve as an intermediary layer between the dynamic operational memory footprint controller and the operating system, providing a standardized set of functions and protocols for communicating adjustment decisions.

The adjustment process may involve gradual changes, such as step-wise increases or decreases, to minimize disruption to the performance of the application. In some implementations, the magnitude of these adjustments may be based on a step size computed during an initialization process. For example, if the candidate adjustment is a step down prediction, the current operational memory footprint limit may be decreased by a fraction of the step size. Conversely, if the candidate adjustment is a step up prediction, the limit may be increased by a multiple of the step size.

In some implementations, the current operational memory footprint limit may refer to a WSS limit in Windows environments or an RSS limit in Unix-like systems. The adjustment process may take into account the specific characteristics and constraints of the operating system environment to improve performance and resource utilization.

After the adjustment is made, the technique 900 may involve a feedback process to evaluate the effectiveness of the adjustment. This may include determining a performance impact corresponding to the adjustment based on activity metrics associated with a period of time subsequent to adjusting the current operational memory footprint. The results of this evaluation may be used to update parameters of the machine learning model, creating a closed-loop system where the outcomes of previous adjustments inform future decisions.

In some implementations, the technique 900 may be part of a larger RL process. This may involve initializing an RL agent associated with a policy, defining states based on activity metrics, selecting actions (adjustments) based on the current state, and updating the policy based on rewards derived from resulting performance metrics. This approach provides a mechanism by which the system may continually refine its adjustment strategies, adapting to changing application behaviors and system conditions over time.

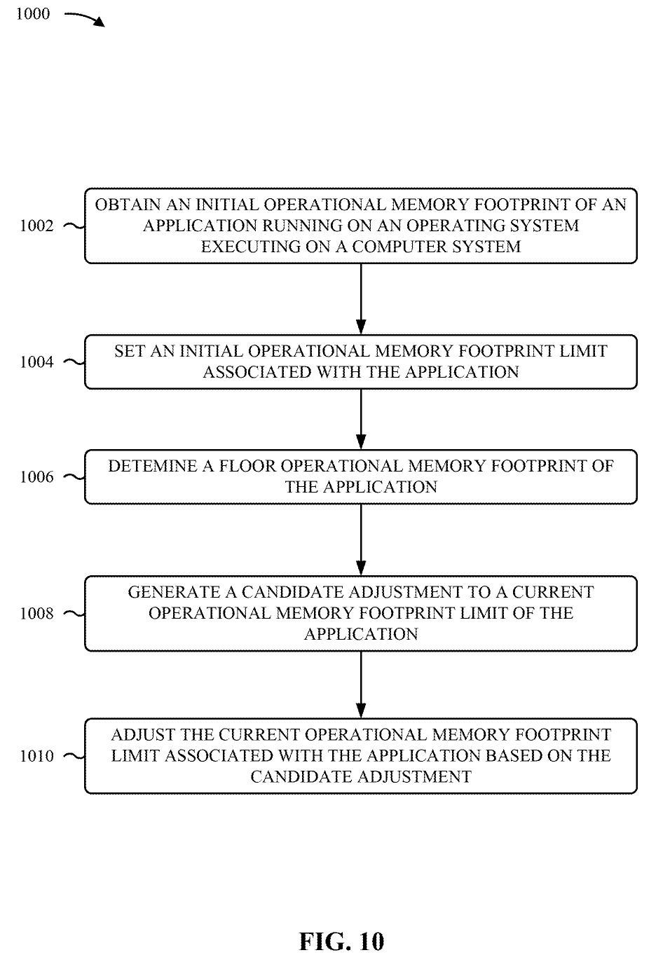

FIG. 10 is a flowchart of an example of a technique 1000 associated with dynamic operational memory footprint optimization. The technique 1000 may be executed using computing devices, such as the systems, hardware, and software described with respect to FIGS. 1 - 9. The technique 1000 may be performed, for example, by executing a machine-readable program or other computer-executable instructions, such as routines, instructions, programs, or other code. The steps, or operations, of the technique 1000, or another technique, method, process, or algorithm described in connection with the implementations disclosed herein may be implemented directly in hardware, firmware, software executed by hardware, circuitry, or a combination thereof.

For simplicity of explanation, the technique 1000 is depicted and described herein as a series of steps or operations. However, the steps or operations of the technique 1000 can occur in various orders and/or concurrently. Additionally, other steps or operations not presented and described herein may be used. Furthermore, not all illustrated steps or operations may be required to implement a technique in accordance with the disclosed subject matter.

At 1002, the technique 1000 includes obtaining an initial operational memory footprint of an application running on an operating system executing on a computer system. For example, a dynamic operational memory footprint controller (such as the dynamic operational memory footprint controller 400 shown in FIG. 4) may obtain an initial operational memory footprint of an application. In some implementations, this step may involve recording the steady-state of the application operational memory footprint under normal operating conditions. The initial operational memory footprint may serve as a baseline for subsequent optimization steps and may be used as a reference point for future adjustments.

In some implementations, obtaining the initial operational memory footprint may involve performing an initial calibration operation to determine an estimated normal operational memory footprint range. This calibration process may take into account various factors such as the typical workload of the application, the available system resources, and historical usage patterns. The initial operational memory footprint may then be set based on this estimated normal range, providing a starting point that reflects the expected behavior of the application under typical conditions.

At 1004, the technique 1000 includes setting an initial operational memory footprint limit associated with the application. For example, an initialization component (such as the initialization component 402 shown in FIG. 4) may set an initial operational memory footprint limit. In some implementations, this step may involve setting the operational memory footprint limit to a value that induces maximum paging-out pressure. This initial limit serves as a starting point for the calibration process and helps establish the lower bounds of acceptable memory usage for the application.

The process of setting the initial operational memory footprint limit may involve careful consideration of system resources and application requirements. In some implementations, the initial limit may be set to a relatively low value to encourage efficient memory usage from the outset. The system may employ various strategies to determine an appropriate initial limit, such as analyzing historical data, considering system-wide memory availability, or using predefined heuristics based on the application type.

At 1006, the technique 1000 includes determining a floor operational memory footprint of the application. For example, the initialization component may determine a floor operational memory footprint by incrementally adjusting an operational memory footprint limit away from the initial operational memory footprint limit in a memory management component of the operating system until a performance metric associated with the application satisfies one or more performance criteria. This process helps identify the lowest operational memory footprint at which the application can operate without substantial performance degradation.

The determination of the floor operational memory footprint may involve a series of iterative adjustments and performance evaluations. In some implementations, the system may start with the initial operational memory footprint limit and gradually increase it while monitoring various performance metrics. These metrics may include factors such as the rate of page faults, application response time, or other indicators of system performance. The process continues until a balance is found between minimizing memory usage and maintaining acceptable application performance.

At 1008, the technique 1000 includes generating a candidate adjustment to a current operational memory footprint limit of the application. For example, a machine learning component (such as the machine learning component 406 shown in FIG. 4) may generate a candidate adjustment based on current activity metrics. These metrics may include process activity metrics corresponding to the application and system activity metrics corresponding to the operating system. The candidate adjustment may be based on a predicted rate of change of memory usage or a predicted rate of change of paging faults obtained from the current activity metrics.

In some implementations, generating the candidate adjustment may involve using a machine learning model, such as a regression model or a decision tree model. This model may be trained on historical data associated with a plurality of operational memory footprint limit adjustment scenarios. The machine learning model may be configured to output various types of predictions, such as a step down prediction, a keep constant prediction, or a step up prediction associated with the current operational memory footprint limit. In some implementations, it may be configured to output a specific magnitude of operational memory footprint limit adjustment.

The process of generating the candidate adjustment may also involve normalizing the current activity metrics relative to the initial operational memory footprint and the floor operational memory footprint. This normalization process may help verify that different metrics are comparable and may be processed effectively by the machine learning model. Additionally, derived metrics may be calculated based on these normalized values, providing further context for the adjustment decision.

At 1010, the technique 1000 includes adjusting the current operational memory footprint limit associated with the application based on the candidate adjustment. For example, an adjustment control component (such as the adjustment control component 408 shown in FIG. 4) may implement the determined adjustments to the operational memory footprint limit. This may involve invoking an API provided by the operating system to modify the limit.

The adjustment process may involve gradual changes, such as step-wise increases or decreases, to minimize disruption to the performance of the application. In some implementations, the magnitude of these adjustments may be based on a step size computed during the initialization process. For example, if the candidate adjustment is a step down prediction, the current operational memory footprint limit may be decreased by a fraction of the step size. Conversely, if the candidate adjustment is a step up prediction, the limit may be increased by a multiple of the step size.

In some implementations, the technique 1000 may incorporate safeguards to prevent overly aggressive memory management that could negatively impact application performance. For instance, the system may be configured with minimum and maximum thresholds for memory allocation, so that the application may have access to a baseline level of resources while reducing the likelihood of excessive memory consumption.

After the adjustment is made, the technique 1000 may involve a feedback process to evaluate the effectiveness of the adjustment. This may include determining a performance impact corresponding to the adjustment based on activity metrics associated with a period of time subsequent to adjusting the current operational memory footprint. The results of this evaluation may be used to update parameters of the machine learning model, creating a closed-loop system where the outcomes of previous adjustments inform future decisions.

In some implementations, the technique 1000 may be part of a larger reinforcement learning process. This may involve initializing an RL agent associated with a policy, defining states based on activity metrics, selecting actions (adjustments) based on the current state, and updating the policy based on rewards derived from resulting performance metrics. This approach provides a mechanism by which the system may continually refine its adjustment strategies, adapting to changing application behaviors and system conditions over time.

The technique 1000 provides a comprehensive approach to dynamic operational memory footprint optimization, balancing efficient memory utilization with maintaining application performance. By incorporating machine learning and adaptive strategies, the technique can potentially enhance overall system performance, reduce unnecessary paging, and improve the efficiency of memory usage across diverse computing scenarios.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to "at least one of" a list of items refers to any combination of those items, including single members. As an example, "at least one of: a, b, or c" is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles "a" and "an" are intended to include one or more items and may be used interchangeably with "one or more." Further, as used herein, the article "the" is intended to include one or more items referenced in connection with the article "the" and may be used interchangeably with "the one or more." Furthermore, as used herein, the terms "set" and "group" are intended to include one or more items (e.g., related items, unrelated items, or a combination of related and unrelated items), and may be used interchangeably with "one or more." Where only one item is intended, the phrase "only one" or similar language is used. Also, as used herein, the terms "has," "have," "having," or the like are intended to be open-ended terms. Further, the phrase "based on" is intended to mean "based, at least in part, on" unless explicitly stated otherwise. Also, as used herein, the term "or" is intended to be inclusive when used in a series and may be used interchangeably with "and/or," unless explicitly stated otherwise (e.g., if used in combination with "either" or "only one of").

The adjectives "first," "second," "third," and so on are used for contextual distinction between two or more of the modified nouns in connection with a discussion and are not meant to be absolute modifiers that apply only to a certain respective node throughout the entire document. For example, a component may be referred to as a "first component" in connection with one discussion and may be referred to as a "second component" in connection with another discussion, or vice versa. Reference to a component, a computing device, a server, a client, an application, an apparatus, a device, a system, a computing system, or the like may include disclosure of the computing device, server, client, application, apparatus, device, system, computing system, or the like, respectively, being a node. For example, disclosure that a computing device is configured to receive information from a server also discloses that a first node is configured to receive information from a second node. Consistent with this disclosure, once a specific example is broadened in accordance with this disclosure (e.g., a computing device is configured to receive information from a server also discloses that a first node is configured to receive information from a second node), the broader example of the narrower example may be interpreted in the reverse, but in a broad open-ended way. In the example above where a computing device being configured to receive information from a server also discloses a first node being configured to receive information from a second node, "first node" may refer to a first computing device, a first server, a first client, a first application, a first apparatus, a first device, a first system, a first computing system, or the like, configured to receive the information from a second node; and "second node" may refer to a second computing device, a second server, a second client, a second application, a second apparatus, a second device, a second system, a second computing system, or the like.

As used herein, unless explicitly stated otherwise, any term specified in the singular may include its plural version. For example, "a computer that stores data and runs software," may include a single computer that stores data and runs software or two computers -- a first computer that stores data and a second computer that runs software. Also "a computer that stores data and runs software," may include multiple computers that together stored data and run software. At least one of the multiple computers stores data, and at least one of the multiple computers runs software.

As used herein, the term "computer-readable medium" encompasses one or more computer readable media. A computer-readable medium may include any storage unit (or multiple storage units) that store data or instructions that are readable by a processing system. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

As used herein, the term "memory subsystem" includes one or more memories, where each memory may be a computer-readable medium. A memory subsystem may encompass memory hardware units (e.g., a hard drive or a disk) that store data or instructions in software form. Alternatively or in addition, the memory subsystem may include data or instructions that are hard-wired into processing system.

A processor may include one or more chips, SoCs, chipsets, packages, or devices that individually or collectively constitute or comprise a processing system. The processing system includes a processor (or "processing") circuitry in the form of one or multiple processors, microprocessors, processing units (such as CPUs, GPUs, NPUs and/or DSPs), processing blocks, ASIC, PLDs (such as FPGAs), or other discrete gate or transistor logic or circuitry (all of which may be generally referred to herein individually as "processors" or collectively as "the processor" or "the processor circuitry"). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as RAM or ROM, or combinations thereof (all of which may be generally referred to herein individually as "memories" or collectively as "the memory" or "the memory circuitry"). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software.

The implementations of this disclosure may be described in terms of functional block components and various processing operations. Such functional block components may be realized by a number of hardware or software components that perform the specified functions. For example, the disclosed implementations can employ various integrated circuit components (e.g., memory elements, processing elements, logic elements, look-up tables, and the like), which may carry out a variety of functions under the control of one or more microprocessors or other control devices. Similarly, where the elements of the disclosed implementations are implemented using software programming or software elements, the systems and techniques may be implemented with a programming or scripting language, such as C, C++, Java, JavaScript, assembler, or the like, with the various algorithms being implemented with a combination of data structures, objects, processes, routines, or other programming elements.

Functional aspects may be implemented in algorithms that execute on one or more processors. Furthermore, the implementations of the systems and techniques disclosed herein could employ a number of conventional techniques for electronics configuration, signal processing or control, data processing, and the like. The words "mechanism" and "component" are used broadly and are not limited to mechanical or physical implementations, but can include software routines in conjunction with processors, etc. Likewise, the terms "system" or "tool" as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium may be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media may be referred to as non-transitory memory or media, and can include volatile memory or non-volatile memory that may change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that may be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
obtaining an initial operational memory footprint of an application running on an operating system executing on a computer system;
setting an initial operational memory footprint limit associated with the application;
determining a floor operational memory footprint of the application by incrementally adjusting an operational memory footprint limit away from the initial operational memory footprint limit in a memory management component of the operating system until a performance metric associated with the application satisfies one or more performance criteria;
generating a candidate adjustment to a current operational memory footprint limit of the application based on a predicted rate of change of memory usage or a predicted rate of change of paging faults obtained based on current activity metrics comprising process activity metrics corresponding to the application and system activity metrics corresponding to the operating system, wherein the candidate adjustment is based on the floor operational memory footprint; and
adjusting the current operational memory footprint limit associated with the application based on the candidate adjustment.

2. The method of claim 1, wherein setting the initial operational memory footprint limit comprises setting the initial operational memory footprint limit to a value that induces a paging-out pressure that satisfies a pressure criterion, and wherein incrementally adjusting the operational memory footprint limit comprises incrementally increasing the operational memory footprint limit until a resulting rate of paging faults satisfies a paging fault criterion.

3. The method of claim 1, further comprising determining an adjustment step size based on a difference between the initial operational memory footprint and the floor operational memory footprint, wherein adjusting the current operational memory footprint limit is based on the adjustment step size.

4. The method of claim 3, wherein generating the candidate adjustment comprises outputting a step down prediction associated with the current operational memory footprint limit based on the current activity metrics indicating that a paging activity metric satisfies a paging criterion and the current activity metrics indicating a stable memory usage or a decreasing memory usage, wherein adjusting the current operational memory footprint limit comprises decreasing the current operational memory footprint limit by a fraction of the adjustment step size.

5. The method of claim 3, wherein generating the candidate adjustment comprises outputting a step up prediction associated with the current operational memory footprint limit based on the current activity metrics indicating that a rate of paging faults is increasing and the current activity metrics indicating an increasing memory usage, wherein adjusting the current operational memory footprint limit comprises increasing the current operational memory footprint limit by a multiple of the adjustment step size.

6. The method of claim 1, further comprising:
determining normalized values of the current activity metrics by normalizing the values relative to the initial operational memory footprint and the floor operational memory footprint; and
determining derived metrics based on the normalized values, wherein generating the candidate adjustment is further based on the derived metrics.

7. The method of claim 1, wherein generating the candidate adjustment comprises generating the candidate adjustment using a machine learning model, the method further comprising:
determining a performance impact corresponding to adjusting the current operational memory footprint limit based on activity metrics associated with a period of time subsequent to adjusting the current operational memory footprint limit; and
updating one or more parameters of the machine learning model based on the performance impact.

8. The method of claim 1, further comprising:
initializing a reinforcement learning agent associated with a policy;
defining a current state based on the current activity metrics, wherein the candidate adjustment comprises an action selected based on the current state;
defining a next state based on next activity metrics obtained subsequent to adjusting the current operational memory footprint limit in accordance with the action;
defining a reward based on one or more resulting performance metrics of the next activity metrics; and
updating the policy based on the reward and the next state.

9. The method of claim 8, wherein defining the reward comprises applying a reward function to the one or more resulting performance metrics, wherein the reward function is configured to:
define a negative reward associated with memory usage that fails to satisfy a memory usage criterion and paging fault rates that fail to satisfy a paging fault criterion, and
define a positive reward associated with operational memory footprint limits that result in the one or more resulting performance metrics satisfying one or more corresponding performance criteria.

10. One or more non-transitory computer-readable media storing instructions that, when executed by one or more processors, cause the one or more processors to:
obtain, by a dynamic operational memory footprint controller of an application running on an operating system, current activity metrics comprising process activity metrics corresponding to the application and system activity metrics corresponding to the operating system;
generate, based on the current activity metrics, a candidate adjustment to a current operational memory footprint limit of the application; and
output an instruction to cause a memory management component of the operating system to adjust the current operational memory footprint limit based on the candidate adjustment.

11. The one or more non-transitory computer-readable media of claim 10, wherein the candidate adjustment is based on a floor operational memory footprint of the application.

12. The one or more non-transitory computer-readable media of claim 10, wherein generating the candidate adjustment comprises generating the candidate adjustment using a machine learning model configured to output a step down prediction associated with the current operational memory footprint limit, a keep constant prediction associated with the current operational memory footprint limit, or a step up prediction associated with the current operational memory footprint limit.

13. The one or more non-transitory computer-readable media of claim 10, wherein generating the candidate adjustment comprises generating the candidate adjustment using a machine learning model comprising a regression model or a decision tree model, and wherein the machine learning model is trained on historical data associated with a plurality of operational memory footprint limit adjustment scenarios.

14. The one or more non-transitory computer-readable media of claim 10, wherein generating the candidate adjustment comprises generating the candidate adjustment using a machine learning model trained using at least one of an offline training operation, an online learning operation, or a reinforcement learning operation.

15. The one or more non-transitory computer-readable media of claim 10, wherein outputting the instruction comprises outputting the instruction to an application programming interface configured to facilitate adjustments to the current operational memory footprint limit.

16. A system, comprising:
one or more processors; and
memory storing instructions that, when executed by the one or more processors, cause the system to:
obtain current activity metrics comprising process activity metrics corresponding to an application executing on the system and system activity metrics corresponding to an operating system of the system;
generate, based on the current activity metrics, a candidate adjustment to a current operational memory footprint limit of the application; and
adjust the current operational memory footprint limit based on the candidate adjustment.

17. The system of claim 16, wherein the current operational memory footprint limit comprises a working set size limit.

18. The system of claim 16, wherein the current operational memory footprint limit comprises a resident set size limit.

19. The system of claim 16, wherein the process activity metrics comprise at least one of a current operational memory footprint of the application, a quantity of hard page faults within a time period, a quantity of soft page faults within the time period, a memory usage trend, or a central processing unit utilization metric associated with the application.

20. The system of claim 16, wherein the system activity metrics comprise at least one of an available memory, a paging file usage metric, a central processing unit utilization metric, or a disk input/output metric associated with paging activities.
